(19) United States
(12) Patent Application Publication
(10) Pub. No.: US 2026/0032274 A1
(43) Pub. Date: Jan. 29, 2026

(54) DECODER WITH JUST-IN-TIME POST-PROCESSING FOR MEMORY SCALABILITY

(71) Applicant: QUALCOMM Incorporated, San Diego, CA (US)

(72) Inventors: Shengqi YANG, Carlsbad, CA (US); Naveen Kumar PONNUSAMY, Bangalore (IN); Sai Kashyap GOBBURI, Nalgonda (IN)

(21) Appl. No.: 18/786,274

(22) Filed: Jul. 26, 2024

(51) Int. Cl. H04N 19/44; H04N 7/01; H04N 19/423

(52) U.S. Cl. CPC H04N 19/44; H04N 7/0117; H04N 19/423

(57) ABSTRACT

Systems and techniques are provided for decoding video data and/or processing video data. In some examples, a codec system decodes an encoded video frame to generate a decoded video frame, and stores the decoded video frame in a memory. In response to an indication that a processed video frame is to be output, the codec system retrieves the decoded video frame from the memory, processes the decoded video frame to generate the processed video frame, and outputs the processed video frame.

### FIELD

The present disclosure generally relates to video processing. For example, aspects of the present disclosure relate to systems and techniques for improving video coding techniques (e.g., encoding and/or decoding video) and/or video processing techniques that separate video frame reconstruction operations from post-processing operations to reduce memory usage and improve video decoding speed and efficiency.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Such devices allow video data to be processed and output for consumption. Digital video data includes large amounts of data to meet the demands of consumers and video providers. For example, consumers of video data desire video of the utmost quality, with high fidelity, resolutions, frame rates, and the like. As a result, the large amount of video data that is required to meet these demands places a burden on communication networks and devices that process and store the video data.

Digital video devices can implement video coding techniques to compress video data. Video coding is performed according to one or more video coding standards or formats. For example, video coding standards or formats include versatile video coding (VVC), high-efficiency video coding (HEVC), advanced video coding (AVC), MPEG-2 Part 2 coding (MPEG stands for moving picture experts group), among others, as well as proprietary video codecs/formats such as AOMedia Video 1 (AV1) that was developed by the Alliance for Open Media. Video coding generally utilizes prediction methods (e.g., inter prediction, intra prediction, or the like) that take advantage of redundancy present in video images or sequences. A goal of video coding techniques is to compress video data into a form that uses a lower bit rate, while avoiding or minimizing degradations to video quality. With ever-evolving video services becoming available, coding techniques with better coding efficiency are needed.

### SUMMARY

Systems and techniques are described herein for decoding video data and/or processing video data. In some examples, a codec system decodes an encoded video frame to generate a decoded video frame, and stores the decoded video frame in a memory. In response to an indication that a processed video frame is to be output, the codec system retrieves the decoded video frame from the memory, processes the decoded video frame to generate the processed video frame, and outputs the processed video frame.

In one example, an apparatus for video decoding and/or video processing is provided. The apparatus includes a memory and one or more processors (e.g., implemented in circuitry) coupled to the memory. The one or more processors are configured to and can: decode encoded video frame data to generate a decoded video frame; store the decoded video frame in a memory of the one or more memories; retrieve the decoded video frame from the memory in response to an indication that a processed video frame is to be output; process the decoded video frame to generate the processed video frame in response to the indication; and output the processed video frame in response to the indication

In another example, a method for video decoding and/or video processing is provided. The method includes: decoding encoded video frame data to generate a decoded video frame; storing the decoded video frame in a memory; retrieving the decoded video frame from the memory in response to an indication that a processed video frame is to be output; processing the decoded video frame to generate the processed video frame in response to the indication; and outputting the processed video frame in response to the indication.

In another example, a non-transitory computer-readable medium is provided that has stored thereon instructions that, when executed by one or more processors, cause the one or more processors to: decode encoded video frame data to generate a decoded video frame; store the decoded video frame in a memory of the one or more memories; retrieve the decoded video frame from the memory in response to an indication that a processed video frame is to be output; process the decoded video frame to generate the processed video frame in response to the indication; and output the processed video frame in response to the indication

In another example, an apparatus for video decoding and/or video processing is provided. The apparatus includes: means for decoding encoded video frame data to generate a decoded video frame; means for storing the decoded video frame in a memory; means for retrieving the decoded video frame from the memory in response to an indication that a processed video frame is to be output; means for processing the decoded video frame to generate the processed video frame in response to the indication; and means for outputting the processed video frame in response to the indication.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, each apparatus includes an image sensor (e.g., a camera) or multiple image sensors (e.g., multiple cameras) for capturing one or more images. In some aspects, each apparatus includes one or more displays for displaying one or more images, notifications, and/or other displayable data. In some aspects, each apparatus includes one or more speakers, one or more light-emitting devices, and/or one or more microphones. In some aspects, each apparatus described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of an encoding device and a decoding device, in accordance with some examples;

FIG. 2 is a block diagram illustrating an example video encoding device, in accordance with some examples;

FIG. 3 is a block diagram illustrating an example video decoding device, in accordance with some examples;

FIG. 4 is a block diagram illustrating an example architecture of a video coding hardware engine, in accordance with some examples;

FIG. 5 is a block diagram illustrating an example architecture of a video coding system, in accordance with some examples;

FIG. 6 is a block diagram illustrating a video codec system with a video decoder and a memory, in accordance with some examples;

FIG. 7A is a block diagram illustrating a bitstream for a video with a group of pictures (GOP) structure with multiple temporal layers and a decode order that differs from a display order, in accordance with some examples;

FIG. 7B is a block diagram illustrating the bitstream for the video of FIG. 7A, with a path overlaid showing how decoding, processing, and display of the video can cause storage of frame data for multiple frames in memory, in accordance with some examples;

FIG. 8A is a block diagram illustrating a video codec system that decodes and processes an encoded frame from a bitstream for a video to generate, and store within a memory, both a reconstructed frame and a processed reconstructed frame, in accordance with some examples;

FIG. 8B is a block diagram illustrating the video codec system of FIG. 8A, with a path overlaid showing how an encoded frame from the bitstream is decoded, processed, and displayed, in accordance with some examples;

FIG. 9A is a block diagram illustrating a video codec system that decodes an encoded frame from a bitstream for a video to generate and store (within the memory) a reconstructed frame, and retrieves the reconstructed frame (from the memory) to generate and output a processed reconstructed frame, in accordance with some examples;

FIG. 9B is a block diagram illustrating the video codec system of FIG. 9A, with a reconstruction path (showing generation and storage of the reconstructed frame) and a processing path (showing generation and output of the processed reconstructed frame) overlaid, in accordance with some examples;

FIG. 10 is a flow diagram illustrating an example of a process for video decoding and/or video processing, in accordance with some examples; and

FIG. 11 is a block diagram illustrating an example of a computing system that can implement the various techniques described herein, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Video coding devices implement video compression techniques to encode and decode video data efficiently. Video compression techniques may include applying different prediction modes, including spatial prediction (e.g., intra-frame prediction or intra-prediction), temporal prediction (e.g., inter-frame prediction or inter-prediction), inter-layer prediction (across different layers of video data), and/or other prediction techniques to reduce or remove redundancy inherent in video sequences. A video encoder can partition each picture of an original video sequence into rectangular regions referred to as video blocks or coding units (described in greater detail below). These video blocks may be encoded using a particular prediction mode.

Video blocks may be divided in one or more ways into one or more groups of smaller blocks. Blocks can include coding tree blocks, prediction blocks, transform blocks, or other suitable blocks. References generally to a “block,” unless otherwise specified, may refer to such video blocks (e.g., coding tree blocks, coding blocks, prediction blocks, transform blocks, or other appropriate blocks or sub-blocks, as would be understood by one of ordinary skill). Further, each of these blocks may also interchangeably be referred to herein as “units” (e.g., coding tree unit (CTU), coding unit, prediction unit (PU), transform unit (TU), or the like). In some cases, a unit may indicate a coding logical unit that is encoded in a bitstream, while a block may indicate a portion of video frame buffer a process is target to.

For inter-prediction modes, a video encoder can search for a block similar to the block being encoded in a frame (or picture) located in another temporal location, referred to as a reference frame or a reference picture. The video encoder may restrict the search to a certain spatial displacement from the block to be encoded. A best match may be located using a two-dimensional (2D) motion vector that includes a horizontal displacement component and a vertical displacement component. For intra-prediction modes, a video encoder may form the predicted block using spatial prediction techniques based on data from previously encoded neighboring blocks within the same picture.

The video encoder may determine a prediction error. For example, the prediction can be determined as the difference between the pixel values in the block being encoded and the predicted block. The prediction error can also be referred to as the residual. The video encoder may also apply a transform to the prediction error (e.g., a discrete cosine transform (DCT) or other suitable transform) to generate transform coefficients. After transformation, the video encoder may quantize the transform coefficients. The quantized transform coefficients and motion vectors may be represented using syntax elements, and, along with control information, form a coded representation of a video sequence. In some instances, the video encoder may entropy encode the quantized transform coefficients and/or the syntax elements, thereby further reducing the number of bits needed for their representation.

After entropy decoding and de-quantizing the received bitstream, a video decoder may, using the syntax elements and control information discussed above, construct predictive data (e.g., a predictive block) for decoding a current frame. For example, the video decoder may add the predicted block and the compressed prediction error. The video decoder may determine the compressed prediction error by weighting the transform basis functions using the quantized coefficients. The difference between the reconstructed frame and the original frame is called reconstruction error.

As used herein, a “video codec” may be used to refer to software or hardware that compresses and/or decompresses digital video data. For example, a video codec can be used to compress raw video data to reduce file size for storage or transmission, and/or to decompress the video file for playback. Compressing video data may also referred to as “encoding” video data. Decompressing video data may also be referred to as “decoding” video data. A video codec IP core can be implemented as a dedicated hardware logic block that is designed for the efficient encoding and decoding (e.g., compression and decompression) of video streams or various other forms of video data. For example, a video codec IP core can be used to perform efficient encoding and decoding operations, and can reduce the power consumption and silicon area needed on-device. The IP core of a video codec IP core can refer to a reusable unit of hardware logic (e.g., a hardware processing block, element, sub-system, etc.) that may be implemented in an integrated circuit, system-on-a-chip (SoC), or other circuitry within a computing device or other apparatus configured to perform video coding. For instance, video codec IP cores can be included in digital video processing systems, and can be integrated into various computing devices such as smartphones, televisions, cameras, etc.

Video coding can be performed according to a particular video coding standard. Examples of video coding standards include, but are not limited to, ITU-T H.261, ISO/IEC MPEG-1 Visual, ITU-T H.262 or ISO/IEC MPEG-2 Visual, ITU-T H.263, ISO/IEC MPEG-4 Visual, Advanced Video Coding (AVC) or ITU-T H.264, including its Scalable Video Coding (SVC) and Multiview Video Coding (MVC) extensions, High Efficiency Video Coding (HEVC) or ITU-T H.265, including its range and screen content coding, 3D video coding (3D-HEVC), multiview (MV-HEVC), and scalable (SHVC) extensions, Versatile Video Coding (VVC) or ITU-T H.266 and its extensions, VP9, Alliance of Open Media (AOMedia) Video 1 (AV1), Essential Video Coding (EVC), among others. Newer generations of video codecs may provide greater compression efficiency, improved video quality, and/or support for higher resolutions and frame rates, etc. For example, more recent video codecs such as HEVC, VP9, VVC, and AV1 can implement more efficient compression that may be used to support applications such as 4K and 8K streaming, etc.

As video coding and video codecs advance to support higher resolutions and frame rates of the video data being encoded and decoded, video codec parallel processing may be utilized. For example, video codec IP cores can implement a plurality of parallel processing pipelines (e.g., also referred to as “pipes”) for parallel encoding and/or decoding of video data. In video codec parallel processing, the task of encoding or decoding video can be divided into smaller, parallel tasks that can be processed simultaneously (e.g., each parallel task can be performed using a corresponding one of the parallel pipes). Distributing a video coding or video processing workload across multiple parallel pipes can reduce an overall processing time for encoding or decoding, and can be used to support higher resolutions of video data, real-time and/or streaming video, etc.

In some examples, each parallel processing pipeline can perform video pixel operations such as motion estimation, motion compensation, transform and quantization, image deblocking, and/or any other video pixel operations. The parallel processing pipelines (and/or each individual processing pipeline) can perform specific video pixel operations in parallel. For example, each processing pipeline can perform multiple operations (and/or process data) simultaneously and/or significantly in parallel. As another example, multiple processing pipelines can perform operations (and/or process data) simultaneously and/or significantly in parallel.

Various video codecs may utilize larger Coding Tree Units (CTUs) and/or may have a larger Largest Coding Unit (LCU) size. Larger LCU sizes can be associated with increasing complexity in balancing video codec workloads in parallel processing architectures. For example, H264 uses an LCU size of 16×16 pixels, while video codecs such as HEVC, VP9, and AV1/VVC use larger LCU sizes up to 128×128 pixels. To process the high pixel throughput associated with ultra-high-resolution content (e.g., such as 8K UHD at 60 frames per second (fps) or 4K UHD at 240 fps, etc.), video codec IP core blocks may utilize parallel processing elements (e.g., such as wavefront processing), with multiple processing pipelines configured to provide increased throughput for higher resolutions and/or higher frame rates.

As a video codec decodes encoded video frames from a bitstream to generate reconstructed video frames, the video codec can store the reconstructed video frames in memory. In some examples, a video codec can store multiple instances of a reconstructed video frame in memory before outputting the reconstructed video frame, for instance by storing a first instance of the reconstructed video frame at the reconstructed resolution without post-processing operation(s) applied, and storing a second instance of the reconstructed video frame at a desired output resolution and/or with post-processing operation(s) applied (e.g., resizing, resampling, rescaling, film grain, color space conversion, format conversion, tone mapping, sharpness adjustment, brightness adjustment, contrast adjustment, color saturation adjustment, other post-processing operations discussed herein, or a combination thereof).

In some examples, a format of the bitstream, and/or which codec is in use, can also cause a memory to store more than one reconstructed video frame in memory, for instance where reconstructing a specific video frame is dependent on data from one or more previously-reconstructed video frames. This effect (e.g., large amount of memory usage) can be exacerbated when a decode order differs from a display order. These aspects, combined, can result in the memory storing a significant amount of data (e.g., a significant number of video frames), for instance including multiple reconstructed video frames and, in some cases, processed variants of one or more of the reconstructed video frames.

Furthermore, as video codecs advance to support higher resolutions and frame rates of the video data being encoded and decoded, the amount of memory needed to store the reconstructed video frames and, in some cases, processed variants thereof, can also increase dramatically. Furthermore, as users move toward smaller portable devices (e.g., phones, watches, rings, glasses, HMDs, wearable devices, and/or other portable devices), space in memory can be increasingly limited in such devices. Thus, there is a need for improved memory management for video coding hardware architectures and/or for video coding operations.

Systems, apparatuses, processes (also referred to as methods), and computer-readable media (collectively referred to as “systems and techniques”) are described herein that can be used to perform video coding (e.g., encoding and/or decoding video data) and/or video processing with reduced memory usage. For example, the systems and techniques can separate decoding operations from post-processing operations. Decoding operations can be used to decode encoded video data to generate a reconstructed frame (or decoded frame), which the systems and techniques can store in memory (e.g., without performing post-processing). The systems and techniques can avoid storing any other instances of the reconstructed frame in memory, at least until an indication is received that the reconstructed frame is to be output (e.g., is to be displayed or transmitted). Once the indication is received that the reconstructed frame is to be output (e.g., is to be displayed or transmitted), the systems and techniques can retrieve the reconstructed frame from memory and apply post-processing operations to the reconstructed frame (e.g., in a just-in-time fashion) to generate a processed reconstructed frame. The systems and techniques can then output the processed reconstructed frame, for instance by sending the processed reconstructed frame directly to an output device (e.g., a display or a transmitter) or by temporarily storing the processed reconstructed frame in a cache or buffer that the output device reads from (e.g., a system cache, a display buffer, the memory, or the like). For instance, in some examples, a codec system (associated with the systems and techniques) decodes encoded video frame data to generate a decoded video frame, and stores the decoded video frame in a memory. In response to an indication that a processed video frame is to be output, the codec system retrieves the decoded video frame from the memory, processes the decoded video frame to generate the processed video frame, and outputs the processed video frame.

In some examples, just-in-time nature of the post-processing operations reduces how much memory is used storing reconstructed video frame data, as the memory only stores a single instance of a reconstructed frame, without storing the processed reconstructed frame. In some examples, the memory (or the system cache, display buffer, or another cache or buffer that the output device reads from) temporarily stores the processed reconstructed frame so that the output device can output the processed reconstructed frame, but ultimately stores the processed reconstructed frame for a shorter amount of time, still reducing memory usage. In some examples, the systems and techniques can further reduce memory bandwidth usage and improve efficiency by reducing the total number of write and/or read operations for decoding a video.

Further aspects of the systems and techniques are described with reference to the figures.

As noted above, the systems and techniques described herein can be applied to any of the existing video codecs, such as Versatile Video Coding (VVC), High Efficiency Video Coding (HEVC), Advanced Video Coding (AVC), Essential Video Coding (EVC), VP9, the AV1 format/codec, and/or other video coding standard, codec, format, etc. in development or to be developed.

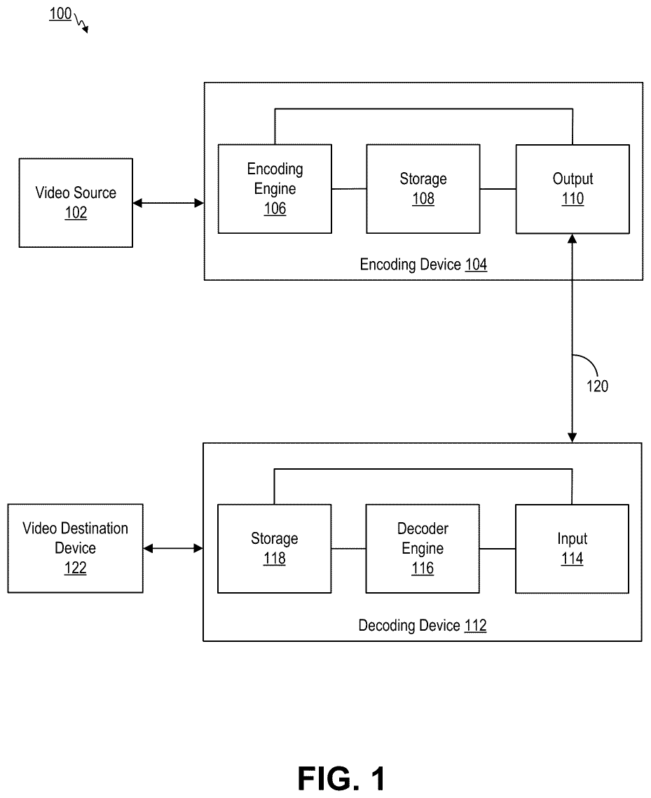

FIG. 1 is a block diagram illustrating an example of a system 100 including an encoding device 104 and a decoding device 112. The encoding device 104 may be part of a source device, and the decoding device 112 may be part of a receiving device. The source device and/or the receiving device may include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the source device and the receiving device may include one or more wireless transceivers for wireless communications. The coding techniques described herein are applicable to video coding in various multimedia applications, including streaming video transmissions (e.g., over the Internet), television broadcasts or transmissions, encoding of digital video for storage on a data storage medium, decoding of digital video stored on a data storage medium, or other applications. As used herein, the term coding can refer to encoding and/or decoding. In some examples, the system 100 can support one-way or two-way video transmission to support applications such as video conferencing, video streaming, video playback, video broadcasting, gaming, and/or video telephony.

The encoding device 104 (or encoder) can be used to encode video data using a video coding standard, format, codec, or protocol to generate an encoded video bitstream. Examples of video coding standards and formats/codecs include ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 (also known as ISO/IEC MPEG-4 AVC), including its Scalable Video Coding (SVC) and Multiview Video Coding (MVC) extensions, High Efficiency Video Coding (HEVC) or ITU-T H.265, and Versatile Video Coding (VVC) or ITU-T H.266. Various extensions to HEVC deal with multi-layer video coding exist, including the range and screen content coding extensions, 3D video coding (3D-HEVC) and multiview extensions (MV-HEVC) and scalable extension (SHVC). The HEVC and its extensions have been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG). VP9, AOMedia Video 1 (AV1) developed by the Alliance for Open Media Alliance of Open Media (AOMedia), and Essential Video Coding (EVC) are other video coding standards for which the techniques described herein can be applied.

The systems and techniques described herein can be applied to any of the existing video codecs (e.g., VVC, HEVC, AVC, or other suitable existing video codec), and/or can be an efficient coding tool for any video coding standards being developed and/or future video coding standards. For example, examples described herein can be performed using video codecs such as VVC, HEVC, AVC, and/or extensions thereof. However, the techniques and systems described herein may also be applicable to other coding standards, codecs, or formats, such as MPEG, JPEG (or other coding standard for still images), VP9, AV1, extensions thereof, or other suitable coding standards already available or not yet available or developed. For instance, in some examples, the encoding device 104 and/or the decoding device 112 may operate according to a proprietary video codec/format, such as AV1, extensions of AV1, and/or successor versions of AV1 (e.g., AV2), or other proprietary formats or industry standards. Accordingly, while the techniques and systems described herein may be described with reference to a particular video coding standard, one of ordinary skill in the art will appreciate that the description should not be interpreted to apply only to that particular standard.

Referring to FIG. 1, a video source 102 may provide the video data to the encoding device 104. The video source 102 may be part of the source device or may be part of a device other than the source device. The video source 102 may include a video capture device (e.g., a video camera, a camera phone, a video phone, or the like), a video archive containing stored video, a video server or content provider providing video data, a video feed interface receiving video from a video server or content provider, a computer graphics system for generating computer graphics video data, a combination of such sources, or any other suitable video source.

The video data from the video source 102 may include one or more input pictures or frames. A picture or frame is a still image that, in some cases, is part of a video. In some examples, data from the video source 102 can be a still image that is not a part of a video. In HEVC, VVC, and other video coding specifications, a video sequence can include a series of pictures. A picture may include three sample arrays, denoted SL, SCb, and SCr. SL is a two-dimensional array of luma samples, SCb is a two-dimensional array of Cb chrominance samples, and SCr is a two-dimensional array of Cr chrominance samples. Chrominance samples may also be referred to herein as “chroma” samples. A pixel can refer to all three components (luma and chroma samples) for a given location in an array of a picture. In other instances, a picture may be monochrome and may only include an array of luma samples, in which case the terms pixel and sample can be used interchangeably. With respect to example techniques described herein that refer to individual samples for illustrative purposes, the same techniques can be applied to pixels (e.g., all three sample components for a given location in an array of a picture). With respect to example techniques described herein that refer to pixels (e.g., all three sample components for a given location in an array of a picture) for illustrative purposes, the same techniques can be applied to individual samples.

The encoder engine 106 (or encoder) of the encoding device 104 encodes the video data to generate an encoded video bitstream. In some examples, an encoded video bitstream (or “video bitstream” or “bitstream”) is a series of one or more coded video sequences. A coded video sequence (CVS) includes a series of access units (AUs) starting with an AU that has a random-access point picture in the base layer and with certain properties up to and not including a next AU that has a random-access point picture in the base layer and with certain properties. For example, the certain properties of a random-access point picture that starts a CVS may include a RASL flag (e.g., NoRaslOutputFlag) equal to 1. Otherwise, a random-access point picture (with RASL flag equal to 0) does not start a CVS. An access unit (AU) includes one or more coded pictures and control information corresponding to the coded pictures that share the same output time. Coded slices of pictures are encapsulated in the bitstream level into data units called network abstraction layer (NAL) units. For example, an HEVC video bitstream may include one or more CVSs including NAL units. Each of the NAL units has a NAL unit header. In one example, the header is one-byte for H.264/AVC (except for multi-layer extensions) and two-byte for HEVC. The syntax elements in the NAL unit header take the designated bits and therefore are visible to all kinds of systems and transport layers, such as Transport Stream, Real-time Transport (RTP) Protocol, File Format, among others.

Two classes of NAL units exist in the HEVC standard, including video coding layer (VCL) NAL units and non-VCL NAL units. A VCL NAL unit includes one slice or slice segment (described below) of coded picture data, and a non-VCL NAL unit includes control information that relates to one or more coded pictures. In some cases, a NAL unit can be referred to as a packet. An HEVC AU includes VCL NAL units containing coded picture data and non-VCL NAL units (if any) corresponding to the coded picture data. Non-VCL NAL units may contain parameter sets with high-level information relating to the encoded video bitstream, in addition to other information. For example, a parameter set may include a video parameter set (VPS), a sequence parameter set (SPS), and a picture parameter set (PPS). In some cases, each slice or other portion of a bitstream can reference a single active PPS, SPS, and/or VPS to allow the decoding device 112 to access information that may be used for decoding the slice or other portion of the bitstream.

NAL units may contain a sequence of bits forming a coded representation of the video data (e.g., an encoded video bitstream, a CVS of a bitstream, or the like), such as coded representations of pictures in a video. The encoder engine 106 generates coded representations of pictures by partitioning each picture into multiple slices. A slice is independent of other slices so that information in the slice is coded without dependency on data from other slices within the same picture. A slice includes one or more slice segments including an independent slice segment and, if present, one or more dependent slice segments that depend on previous slice segments.

In HEVC, the slices are then partitioned into coding tree blocks (CTBs) of luma samples and chroma samples. A CTB of luma samples and one or more CTBs of chroma samples, along with syntax for the samples, are referred to as a coding tree unit (CTU). A CTU may also be referred to as a “tree block” or a “largest coding unit” (LCU). A CTU is the basic processing unit for HEVC encoding. A CTU can be split into multiple coding units (CUs) of varying sizes. A CU contains luma and chroma sample arrays that are referred to as coding blocks (CBs).

The luma and chroma CBs can be further split into prediction blocks (PBs). A PB is a block of samples of the luma component or a chroma component that uses the same motion parameters for inter-prediction or intra-block copy prediction (when available or enabled for use). The luma PB and one or more chroma PBs, together with associated syntax, form a prediction unit (PU). For inter-prediction, a set of motion parameters (e.g., one or more motion vectors, reference indices, or the like) is signaled in the bitstream for each PU and is used for inter-prediction of the luma PB and the one or more chroma PBs. The motion parameters can also be referred to as motion information. A CB can also be partitioned into one or more transform blocks (TBs). A TB represents a square block of samples of a color component on which a residual transform (e.g., the same two-dimensional transform in some cases) is applied for coding a prediction residual signal. A transform unit (TU) represents the TBs of luma and chroma samples, and corresponding syntax elements. Transform coding is described in more detail below.

A size of a CU corresponds to a size of the coding mode and may be square in shape. For example, a size of a CU may be 8×8 samples, 16×16 samples, 32×32 samples, 64×64 samples, or any other appropriate size up to the size of the corresponding CTU. The phrase “N×N” is used herein to refer to pixel dimensions of a video block in terms of vertical and horizontal dimensions (e.g., 8 pixels×8 pixels). The pixels in a block may be arranged in rows and columns. In some examples, blocks may not have the same number of pixels in a horizontal direction as in a vertical direction. Syntax data associated with a CU may describe, for example, partitioning of the CU into one or more PUs. Partitioning modes may differ between whether the CU is intra-prediction mode encoded or inter-prediction mode encoded. PUs may be partitioned to be non-square in shape. Syntax data associated with a CU may also describe, for example, partitioning of the CU into one or more TUs according to a CTU. A TU can be square or non-square in shape.

According to the HEVC standard, transformations may be performed using transform units (TUs). TUs may vary for different CUs. The TUs may be sized based on the size of PUs within a given CU. The TUs may be the same size or smaller than the PUs. In some examples, residual samples corresponding to a CU may be subdivided into smaller units using a quadtree structure known as residual quad tree (RQT). Leaf nodes of the RQT may correspond to TUs. Pixel difference values associated with the TUs may be transformed to produce transform coefficients. The transform coefficients may be quantized by the encoder engine 106.

Once the pictures of the video data are partitioned into CUs, the encoder engine 106 predicts each PU using a prediction mode. The prediction unit or prediction block is subtracted from the original video data to get residuals (described below). For each CU, a prediction mode may be signaled inside the bitstream using syntax data. A prediction mode may include intra-prediction (or intra-picture prediction) or inter-prediction (or inter-picture prediction). Intra-prediction utilizes the correlation between spatially neighboring samples within a picture. For example, using intra-prediction, each PU is predicted from neighboring image data in the same picture using, for example, DC prediction to find an average value for the PU, planar prediction to fit a planar surface to the PU, direction prediction to extrapolate from neighboring data, or any other suitable types of prediction. Inter-prediction uses the temporal correlation between pictures in order to derive a motion-compensated prediction for a block of image samples. For example, using inter-prediction, each PU is predicted using motion compensation prediction from image data in one or more reference pictures (before or after the current picture in output order). The decision whether to code a picture area using inter-picture or intra-picture prediction may be made, for example, at the CU level.

The encoder engine 106 and the decoder engine 116 (described in more detail below) may be configured to operate according to VVC. According to VVC, a video coder (such as the encoder engine 106 and/or the decoder engine 116) partitions a picture into a plurality of coding tree units (CTUs) (where a CTB of luma samples and one or more CTBs of chroma samples, along with syntax for the samples, are referred to as a CTU). The video coder can partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels, including a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree partition, a binary tree partition, and one or more types of triple tree partitions. A triple tree partition is a partition where a block is split into three sub-blocks. In some examples, a triple tree partition divides a block into three sub-blocks without dividing the original block through the center. The partitioning types in MTT (e.g., quadtree, binary tree, and tripe tree) may be symmetrical or asymmetrical.

When operating according to the AV1 codec, encoder engine 106 (and/or encoding device 104) and decoder engine 116 (and/or decoding device 112) may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Encoder engine 106 (and/or encoding device 104) may further partition a superblock into smaller coding blocks. Encoder engine 106 (and/or encoding device 104) may partition a superblock and other coding blocks into smaller blocks using square or non-square partitioning. Non-square blocks may include N/2×N, N×N/2, N/4×N, and N×N/4 blocks. Encoder engine 106 (and/or encoding device 104) and decoder engine 116 (and/or decoding device 112) may perform separate prediction and transform processes on each of the coding blocks.

AV1 also defines a tile of video data. A tile is a rectangular array of superblocks that may be coded independently of other tiles. That is, encoder engine 106 (and/or encoding device 104) and decoder engine 116 (and/or decoding device 112) may encode and decode, respectively, coding blocks within a tile without using video data from other tiles. However, encoder engine 106 (and/or encoding device 104) and decoder engine 116 (and/or decoding device 112) may perform filtering across tile boundaries. Tiles may be uniform or non-uniform in size. Tile-based coding may enable parallel processing and/or multi-threading for encoder and decoder implementations.

In some examples, the video coder can use a single QTBT or MTT structure to represent each of the luminance and chrominance components, while in other examples, the video coder can use two or more QTBT or MTT structures, such as one QTBT or MTT structure for the luminance component and another QTBT or MTT structure for both chrominance components (or two QTBT and/or MTT structures for respective chrominance components).

The video coder can be configured to use quadtree partitioning per HEVC, QTBT partitioning, MTT partitioning, or other partitioning structures.

In some examples, the one or more slices of a picture are assigned a slice type. Slice types include an I slice, a P slice, and a B slice. An I slice (intra-frames, independently decodable) is a slice of a picture that is only coded by intra-prediction, and therefore is independently decodable since the I slice requires only the data within the frame to predict any prediction unit or prediction block of the slice. A P slice (uni-directional predicted frames) is a slice of a picture that may be coded with intra-prediction and with uni-directional inter-prediction. Each prediction unit or prediction block within a P slice is either coded with intra prediction or inter-prediction. When the inter-prediction applies, the prediction unit or prediction block is only predicted by one reference picture, and therefore reference samples are only from one reference region of one frame. A B slice (bi-directional predictive frames) is a slice of a picture that may be coded with intra-prediction and with inter-prediction (e.g., either bi-prediction or uni-prediction). A prediction unit or prediction block of a B slice may be bi-directionally predicted from two reference pictures, where each picture contributes one reference region and sample sets of the two reference regions are weighted (e.g., with equal weights or with different weights) to produce the prediction signal of the bi-directional predicted block. As explained above, slices of one picture are independently coded. In some cases, a picture can be coded as just one slice.

As noted above, intra-picture prediction utilizes the correlation between spatially neighboring samples within a picture. There is a plurality of intra-prediction modes (also referred to as “intra modes”). In some examples, the intra prediction of a luma block includes 35 modes, including the Planar mode, DC mode, and 33 angular modes (e.g., diagonal intra-prediction modes and angular modes adjacent to the diagonal intra-prediction modes). The 35 modes of the intra prediction are indexed as shown in Table 1 below. In other examples, more intra modes may be defined including prediction angles that may not already be represented by the 33 angular modes. In other examples, the prediction angles associated with the angular modes may be different from those used in HEVC.

TABLE 1
Specification of intra-prediction mode and associated names

| Intra-prediction | |
|---|---|
| mode | Associated name |
| 0 | INTRA_PLANAR |
| 1 | INTRA_DC |
| 2 . . . 34 | INTRA_ANGULAR2 . . . INTRA_ANGULAR34 |

Inter-picture prediction uses the temporal correlation between pictures in order to derive a motion-compensated prediction for a current block of image samples. Using a translational motion model, the position of a block in a previously decoded picture (a reference picture) is indicated by a motion vector (Δx, Δy), with Δx specifying the horizontal displacement and Δy specifying the vertical displacement of the reference block relative to the position of the current block. In some cases, a motion vector (Δx, Δy) can be in integer sample accuracy (also referred to as integer accuracy), in which case the motion vector points to the integer-pel grid (or integer-pixel sampling grid) of the reference frame. In some cases, a motion vector (Δx, Δy) can be of fractional sample accuracy (also referred to as fractional-pel accuracy or non-integer accuracy) to more accurately capture the movement of the underlying object, without being restricted to the integer-pel grid of the reference frame. Accuracy of motion vectors may be expressed by the quantization level of the motion vectors. For example, the quantization level may be integer accuracy (e.g., 1-pixel) or fractional-pel accuracy (e.g., ¼-pixel, ½-pixel, or other sub-pixel value). Interpolation is applied on reference pictures to derive the prediction signal when the corresponding motion vector has fractional sample accuracy. For example, samples available at integer positions can be filtered (e.g., using one or more interpolation filters) to estimate values at fractional positions. The previously decoded reference picture is indicated by a reference index (refIdx) to a reference picture list. The motion vectors and reference indices can be referred to as motion parameters. Two kinds of inter-picture prediction can be performed, including uni-prediction and bi-prediction.

With inter-prediction using bi-prediction (also referred to as bi-directional inter-prediction), two sets of motion parameters (Δx₀, y₀, refIdx, and Δx₁, y₁, refIdx₁) are used to generate two motion compensated predictions (from the same reference picture or possibly from different reference pictures). For example, with bi-prediction, each prediction block uses two motion compensated prediction signals, and generates B prediction units. The two motion compensated predictions are combined to get the final motion compensated prediction. For example, the two motion compensated predictions can be combined by averaging. In another example, weighted prediction can be used, in which case different weights can be applied to each motion compensated prediction. The reference pictures that can be used in bi-prediction are stored in two separate lists, denoted as list 0 and list 1. Motion parameters can be derived at the encoding device 104 using a motion estimation process.

With inter-prediction using uni-prediction (also referred to as uni-directional inter-prediction), one set of motion parameters (Δx₀, y₀, refIdx₀) is used to generate a motion compensated prediction from a reference picture. For example, with uni-prediction, each prediction block uses at most one motion compensated prediction signal, and generates P prediction units.

A PU may include the data (e.g., motion parameters or other suitable data) related to the prediction process. For example, when the PU is encoded using intra-prediction, the PU may include data describing an intra-prediction mode for the PU. As another example, when the PU is encoded using inter-prediction, the PU may include data defining a motion vector for the PU. The data defining the motion vector for a PU may describe, for example, a horizontal component of the motion vector (Δx), a vertical component of the motion vector (Δy), a resolution for the motion vector (e.g., integer precision, one-quarter pixel precision or one-eighth pixel precision), a reference picture to which the motion vector points, a reference index, a reference picture list (e.g., List 0, List 1, or List C) for the motion vector, or any combination thereof.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, encoding device 104 and decoding device 112 do not use video data from other frames of video data. For most intra prediction modes, the video encoding device 104 encodes blocks of a current frame based on the difference between sample values in the current block and predicted values generated from reference samples in the same frame. The video encoding device 104 determines predicted values generated from the reference samples based on the intra prediction mode.

After performing prediction using intra- and/or inter-prediction, the encoding device 104 can perform transformation and quantization. For example, following prediction, the encoder engine 106 may calculate residual values corresponding to the PU. Residual values may comprise pixel difference values between the current block of pixels being coded (the PU) and the prediction block used to predict the current block (e.g., the predicted version of the current block). For example, after generating a prediction block (e.g., issuing inter-prediction or intra-prediction), the encoder engine 106 can generate a residual block by subtracting the prediction block produced by a prediction unit from the current block. The residual block includes a set of pixel difference values that quantify differences between pixel values of the current block and pixel values of the prediction block. In some examples, the residual block may be represented in a two-dimensional block format (e.g., a two-dimensional matrix or array of pixel values). In such examples, the residual block is a two-dimensional representation of the pixel values.

Any residual data that may be remaining after prediction is performed is transformed using a block transform, which may be based on discrete cosine transform, discrete sine transform, an integer transform, a wavelet transform, other suitable transform function, or any combination thereof. In some cases, one or more block transforms (e.g., sizes 32×32, 16×16, 8×8, 4×4, or other suitable size) may be applied to residual data in each CU. In some examples, a TU may be used for the transform and quantization processes implemented by the encoder engine 106. A given CU having one or more PUs may also include one or more TUs. As described in further detail below, the residual values may be transformed into transform coefficients using the block transforms, and may be quantized and scanned using TUs to produce serialized transform coefficients for entropy coding.

In some examples, following intra-predictive or inter-predictive coding using PUs of a CU, the encoder engine 106 may calculate residual data for the TUs of the CU. The PUs may comprise pixel data in the spatial domain (or pixel domain). The TUs may comprise coefficients in the transform domain following application of a block transform. As previously noted, the residual data may correspond to pixel difference values between pixels of the unencoded picture and prediction values corresponding to the PUs. The encoder engine 106 may form the TUs including the residual data for the CU, and may transform the TUs to produce transform coefficients for the CU.

The encoder engine 106 may perform quantization of the transform coefficients. Quantization provides further compression by quantizing the transform coefficients to reduce the amount of data used to represent the coefficients. For example, quantization may reduce the bit depth associated with some or all of the coefficients. In one example, a coefficient with an n-bit value may be rounded down to an m-bit value during quantization, with n being greater than m.

Once quantization is performed, the coded video bitstream includes quantized transform coefficients, prediction information (e.g., prediction modes, motion vectors, block vectors, or the like), partitioning information, and any other suitable data, such as other syntax data. The different elements of the coded video bitstream may be entropy encoded by the encoder engine 106. In some examples, the encoder engine 106 may utilize a predefined scan order to scan the quantized transform coefficients to produce a serialized vector that can be entropy encoded. In some examples, the encoder engine 106 may perform an adaptive scan. After scanning the quantized transform coefficients to form a vector (e.g., a one-dimensional vector), the encoder engine 106 may entropy encode the vector. For example, the encoder engine 106 may use context adaptive variable length coding, context adaptive binary arithmetic coding, syntax-based context-adaptive binary arithmetic coding, probability interval partitioning entropy coding, or another suitable entropy encoding technique.

The output 110 of the encoding device 104 may send the NAL units making up the encoded video bitstream data over the communication link 120 to the decoding device 112 of the receiving device. The input 114 of the decoding device 112 may receive the NAL units. The communication link 120 may include a channel provided by a wireless network, a wired network, or a combination of a wired and wireless network. A wireless network may include any wireless interface or combination of wireless interfaces and may include any suitable wireless network (e.g., the Internet or other wide area network, a packet-based network, WiFi, radio frequency (RF), UWB, WiFi-Direct, cellular, Long-Term Evolution (LTE), WiMax, or the like). A wired network may include any wired interface (e.g., fiber, ethernet, powerline ethernet, ethernet over coaxial cable, digital signal line (DSL), or the like). The wired and/or wireless networks may be implemented using various equipment, such as base stations, routers, access points, bridges, gateways, switches, or the like. The encoded video bitstream data may be modulated according to a communication standard, such as a wireless communication protocol, and transmitted to the receiving device.

In some examples, the encoding device 104 may store encoded video bitstream data in a storage 108. The output 110 may retrieve the encoded video bitstream data from the encoder engine 106 or from the storage 108. The storage 108 may include any of a variety of distributed or locally accessed data storage media. For example, the storage 108 may include a hard drive, a storage disc, flash memory, volatile or non-volatile memory, or any other suitable digital storage media for storing encoded video data. The storage 108 can also include a decoded picture buffer (DPB) for storing reference pictures for use in inter-prediction. In a further example, the storage 108 can correspond to a file server or another intermediate storage device that may store the encoded video generated by the source device. In such cases, the receiving device including the decoding device 112 can access stored video data from the storage device via streaming or download. The file server may be any type of server capable of storing encoded video data and transmitting that encoded video data to the receiving device. Example file servers include a web server (e.g., for a website), an FTP server, network attached storage (NAS) devices, or a local disk drive. The receiving device may access the encoded video data through any standard data connection, including an Internet connection, and may include a wireless channel (e.g., a Wi-Fi connection), a wired connection (e.g., DSL, cable modem, etc.), or a combination of both that is suitable for accessing encoded video data stored on a file server. The transmission of encoded video data from the storage 108 may be a streaming transmission, a download transmission, or a combination thereof.

The input 114 of the decoding device 112 receives the encoded video bitstream data and may provide the video bitstream data to the decoder engine 116, or to the storage 118 for later use by the decoder engine 116. For example, the storage 118 can include a DPB for storing reference pictures for use in inter-prediction. The receiving device including the decoding device 112 can receive the encoded video data to be decoded via the storage 108. The encoded video data may be modulated according to a communication standard, such as a wireless communication protocol, and transmitted to the receiving device. The communication medium for transmitted the encoded video data can comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device to the receiving device.

The decoder engine 116 may decode the encoded video bitstream data by entropy decoding (e.g., using an entropy decoder) and extracting the elements of one or more coded video sequences making up the encoded video data. The decoder engine 116 may rescale and perform an inverse transform on the encoded video bitstream data. Residual data is passed to a prediction stage of the decoder engine 116. The decoder engine 116 predicts a block of pixels (e.g., a PU). In some examples, the prediction is added to the output of the inverse transform (the residual data).

The decoding device 112 may output the decoded video to a video destination device 122, which may include a display or other output device for displaying the decoded video data to a consumer of the content. In some aspects, the video destination device 122 may be part of the receiving device that includes the decoding device 112. In some aspects, the video destination device 122 may be part of a separate device other than the receiving device.

In some examples, the video encoding device 104 and/or the video decoding device 112 may be integrated with an audio encoding device and audio decoding device, respectively. The video encoding device 104 and/or the video decoding device 112 may also include other hardware or software that is necessary to implement the coding techniques described above, such as one or more microprocessors, digital signal processors (DSPs), application specific integrated circuits (ASICs), field programmable gate arrays (FPGAs), discrete logic, software, hardware, firmware or any combinations thereof. The video encoding device 104 and the video decoding device 112 may be integrated as part of a combined encoder/decoder (codec) in a respective device.

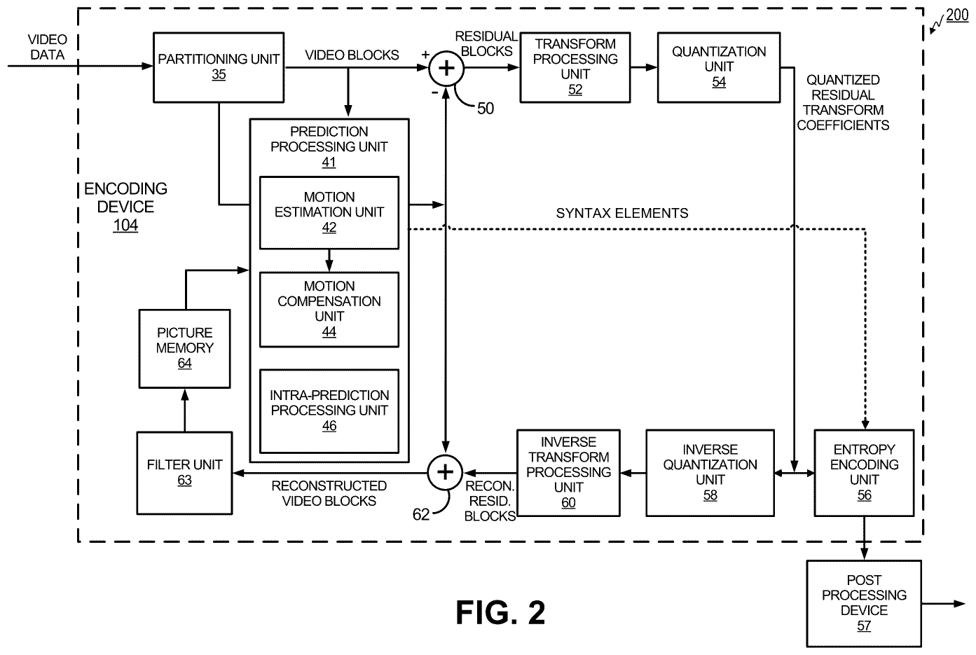

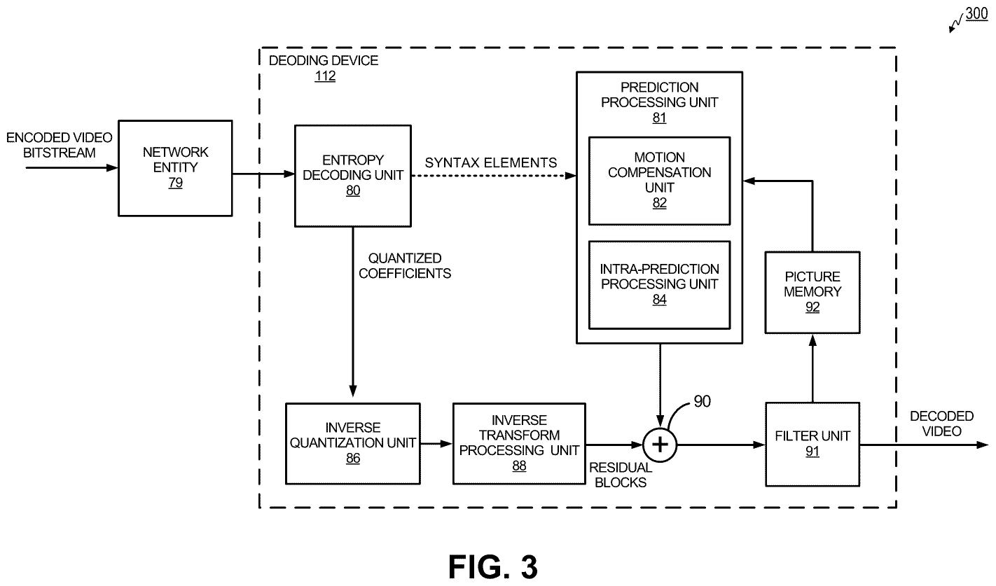

An example of specific details of the encoding device 104 is described below with reference to FIG. 2. An example of specific details of the decoding device 112 is described below with reference to FIG. 3.

The example system shown in FIG. 1 is one illustrative example that can be used herein. Techniques for processing video data using the techniques described herein can be performed by any digital video encoding and/or decoding device. Although generally the techniques of this disclosure are performed by a video encoding device or a video decoding device, the techniques may also be performed by a combined video encoder-decoder, typically referred to as a “CODEC.” Moreover, the techniques of this disclosure may also be performed by a video preprocessor. The source device and the receiving device are merely examples of such coding devices in which the source device generates coded video data for transmission to the receiving device. In some examples, the source and receiving devices may operate in a substantially symmetrical manner such that each of the devices include video encoding and decoding components. Hence, example systems may support one-way or two-way video transmission between video devices, e.g., for video streaming, video playback, video broadcasting, or video telephony.

Extensions to the HEVC standard include the Multiview Video Coding extension, referred to as MV-HEVC, and the Scalable Video Coding extension, referred to as SHVC. The MV-HEVC and SHVC extensions share the concept of layered coding, with different layers being included in the encoded video bitstream. Each layer in a coded video sequence is addressed by a unique layer identifier (ID). A layer ID may be present in a header of a NAL unit to identify a layer with which the NAL unit is associated. In MV-HEVC, different layers usually represent different views of the same scene in the video bitstream. In SHVC, different scalable layers are provided that represent the video bitstream in different spatial resolutions (or picture resolution) or in different reconstruction fidelities. The scalable layers may include a base layer (with layer ID=0) and one or more enhancement layers (with layer IDs=1, 2, . . . n). The base layer may conform to a profile of the first version of HEVC, and represents the lowest available layer in a bitstream. The enhancement layers have increased spatial resolution, temporal resolution or frame rate, and/or reconstruction fidelity (or quality) as compared to the base layer. The enhancement layers are hierarchically organized and may (or may not) depend on lower layers. In some examples, the different layers may be coded using a single standard codec (e.g., all layers are encoded using HEVC, SHVC, or other coding standard). In some examples, different layers may be coded using a multi-standard codec. For example, a base layer may be coded using AVC, while one or more enhancement layers may be coded using SHVC and/or MV-HEVC extensions to the HEVC standard.

In general, a layer includes a set of VCL NAL units and a corresponding set of non-VCL NAL units. The NAL units are assigned a particular layer ID value. Layers can be hierarchical in the sense that a layer may depend on a lower layer. A layer set refers to a set of layers represented within a bitstream that are self-contained, meaning that the layers within a layer set can depend on other layers in the layer set in the decoding process, but do not depend on any other layers for decoding. Accordingly, the layers in a layer set can form an independent bitstream that can represent video content. The set of layers in a layer set may be obtained from another bitstream by operation of a sub-bitstream extraction process. A layer set may correspond to the set of layers that is to be decoded when a decoder wants to operate according to certain parameters.

As previously described, an HEVC bitstream includes a group of NAL units, including VCL NAL units and non-VCL NAL units. VCL NAL units include coded picture data forming a coded video bitstream. For example, a sequence of bits forming the coded video bitstream is present in VCL NAL units. Non-VCL NAL units may contain parameter sets with high-level information relating to the encoded video bitstream, in addition to other information. For example, a parameter set may include a video parameter set (VPS), a sequence parameter set (SPS), and a picture parameter set (PPS). Examples of goals of the parameter sets include bit rate efficiency, error resiliency, and providing systems layer interfaces. Each slice references a single active PPS, SPS, and VPS to access information that the decoding device 112 may use for decoding the slice. An identifier (ID) may be coded for each parameter set, including a VPS ID, an SPS ID, and a PPS ID. An SPS includes an SPS ID and a VPS ID. A PPS includes a PPS ID and an SPS ID. Each slice header includes a PPS ID. Using the IDs, active parameter sets can be identified for a given slice.

A PPS includes information that applies to all slices in a given picture. In some examples, all slices in a picture refer to the same PPS. Slices in different pictures may also refer to the same PPS. An SPS includes information that applies to all pictures in a same coded video sequence (CVS) or bitstream. As previously described, a coded video sequence is a series of access units (AUs) that starts with a random access point picture (e.g., an instantaneous decode reference (IDR) picture or broken link access (BLA) picture, or other appropriate random access point picture) in the base layer and with certain properties (described above) up to and not including a next AU that has a random access point picture in the base layer and with certain properties (or the end of the bitstream). The information in an SPS may not change from picture to picture within a coded video sequence. Pictures in a coded video sequence may use the same SPS. The VPS includes information that applies to all layers within a coded video sequence or bitstream. The VPS includes a syntax structure with syntax elements that apply to entire coded video sequences. In some examples, the VPS, SPS, or PPS may be transmitted in-band with the encoded bitstream. In some examples, the VPS, SPS, or PPS may be transmitted out-of-band in a separate transmission than the NAL units containing coded video data.

This disclosure may generally refer to “signaling” certain information, such as syntax elements. The term “signaling” may generally refer to the communication of values for syntax elements and/or other data used to decode encoded video data. For example, the video encoding device 104 may signal values for syntax elements in the bitstream. In general, signaling refers to generating a value in the bitstream. As noted above, video source 102 may transport the bitstream to video destination device 122 substantially in real time, or not in real time, such as might occur when storing syntax elements to storage 108 for later retrieval by the video destination device 122.

Specific details of the encoding device 104 and the decoding device 112 are shown in FIG. 2 and FIG. 3, respectively. FIG. 2 is a block diagram 200 illustrating an example encoding device 104 that may implement one or more of the techniques described in this disclosure. Encoding device 104 may, for example, generate the syntax structures described herein (e.g., the syntax structures of a VPS, SPS, PPS, or other syntax elements). Encoding device 104 may perform intra-prediction and inter-prediction coding of video blocks within video slices. As previously described, intra-coding relies, at least in part, on spatial prediction to reduce or remove spatial redundancy within a given video frame or picture. Inter-coding relies, at least in part, on temporal prediction to reduce or remove temporal redundancy within adjacent or surrounding frames of a video sequence. Intra-mode (I mode) may refer to any of several spatial based compression modes. Inter-modes, such as uni-directional prediction (P mode) or bi-prediction (B mode), may refer to any of several temporal-based compression modes.

The encoding device 104 includes a partitioning unit 35, prediction processing unit 41, filter unit 63, picture memory 64, summer 50, transform processing unit 52, quantization unit 54, and entropy encoding unit 56. Prediction processing unit 41 includes motion estimation unit 42, motion compensation unit 44, and intra-prediction processing unit 46. For video block reconstruction, encoding device 104 also includes inverse quantization unit 58, inverse transform processing unit 60, and summer 62. Filter unit 63 is intended to represent one or more loop filters such as a deblocking filter, an adaptive loop filter (ALF), and a sample adaptive offset (SAO) filter. Although filter unit 63 is shown in FIG. 3 as being an in-loop filter, in other configurations, filter unit 63 may be implemented as a post loop filter. A post processing device 57 may perform additional processing on encoded video data generated by the encoding device 104. The techniques of this disclosure may in some instances be implemented by the encoding device 104. In other instances, however, one or more of the techniques of this disclosure may be implemented by post processing device 57.

As shown in FIG. 2, the encoding device 104 receives video data, and partitioning unit 35 partitions the data into video blocks. The partitioning may also include partitioning into slices, slice segments, tiles, or other larger units, as wells as video block partitioning, e.g., according to a quadtree structure of LCUs (e.g., CTUs) and CUs. The encoding device 104 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra-prediction coding modes or one of a plurality of inter-prediction coding modes, for the current video block based on error results (e.g., coding rate and the level of distortion, or the like). Prediction processing unit 41 may provide the resulting intra- or inter-coded block to summer 50 to generate residual block data and to summer 62 to reconstruct the encoded block for use as a reference picture.

Intra-prediction processing unit 46 within prediction processing unit 41 may perform intra-prediction coding of the current video block relative to one or more neighboring blocks in the same frame or slice as the current block to be coded to provide spatial compression. Motion estimation unit 42 and motion compensation unit 44 within prediction processing unit 41 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices, B slices, or GPB slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a prediction unit (PU) of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, the encoding device 104 may calculate values for sub-integer pixel positions of reference pictures stored in picture memory 64. For example, the encoding device 104 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in a reference picture list. The encoding device 104 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by the decoding device 112 in decoding the video blocks of the video slice.

Intra-prediction processing unit 46 may intra-predict a current block, as an alternative to the inter-prediction performed by motion estimation unit 42 and motion compensation unit 44, as described above. In particular, intra-prediction processing unit 46 may determine an intra-prediction mode to use to encode a current block. In some examples, intra-prediction processing unit 46 may encode a current block using various intra-prediction modes, e.g., during separate encoding passes, and intra-prediction processing unit 46 may select an appropriate intra-prediction mode to use from the tested modes. For example, intra-prediction processing unit 46 may calculate rate-distortion values using a rate-distortion analysis for the various tested intra-prediction modes, and may select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction processing unit 46 may calculate ratios from the distortions and rates for the various encoded blocks to determine which intra-prediction mode exhibits the best rate-distortion value for the block.

In any case, after selecting an intra-prediction mode for a block, intra-prediction processing unit 46 may provide information indicative of the selected intra-prediction mode for the block to entropy encoding unit 56. Entropy encoding unit 56 may encode the information indicating the selected intra-prediction mode. The encoding device 104 may include in the transmitted bitstream configuration data definitions of encoding contexts for various blocks as well as indications of a most probable intra-prediction mode, an intra-prediction mode index table, and a modified intra-prediction mode index table to use for each of the contexts. The bitstream configuration data may include a plurality of intra-prediction mode index tables and a plurality of modified intra-prediction mode index tables (also referred to as codeword mapping tables).

After prediction processing unit 41 generates the predictive block for the current video block via either inter-prediction or intra-prediction, the encoding device 104 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding technique. Following the entropy encoding by entropy encoding unit 56, the encoded bitstream may be transmitted to the decoding device 112, or archived for later transmission or retrieval by the decoding device 112. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within a reference picture list. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reference block for storage in picture memory 64. The reference block may be used by motion estimation unit 42 and motion compensation unit 44 as a reference block to inter-predict a block in a subsequent video frame or picture.

In this manner, the encoding device 104 of FIG. 2 represents an example of a video encoder configured to perform the techniques described herein. For instance, the encoding device 104 may perform any of the techniques described herein, including the processes described herein. In some cases, some of the techniques of this disclosure may also be implemented by post processing device 57.

FIG. 3 is a block diagram 300 illustrating an example decoding device 112. The decoding device 112 includes an entropy decoding unit 80, prediction processing unit 81, inverse quantization unit 86, inverse transform processing unit 88, summer 90, filter unit 91, and picture memory 92. Prediction processing unit 81 includes motion compensation unit 82 and intra prediction processing unit 84. The decoding device 112 may, in some examples, perform a decoding pass generally reciprocal to the encoding pass described with respect to the encoding device 104 from FIG. 2.

During the decoding process, the decoding device 112 receives an encoded video bitstream that represents video blocks of an encoded video slice and associated syntax elements sent by the encoding device 104. In some examples, the decoding device 112 may receive the encoded video bitstream from the encoding device 104. In some examples, the decoding device 112 may receive the encoded video bitstream from a network entity 79, such as a server, a media-aware network element (MANE), a video editor/splicer, or other such device configured to implement one or more of the techniques described above. Network entity 79 may or may not include the encoding device 104. Some of the techniques described in this disclosure may be implemented by network entity 79 prior to network entity 79 transmitting the encoded video bitstream to the decoding device 112. In some video decoding systems, network entity 79 and the decoding device 112 may be parts of separate devices, while in other instances, the functionality described with respect to network entity 79 may be performed by the same device that comprises the decoding device 112.

The entropy decoding unit 80 of the decoding device 112 entropy decodes the bitstream to generate quantized coefficients, motion vectors, and other syntax elements. Entropy decoding unit 80 forwards the motion vectors and other syntax elements to prediction processing unit 81. The decoding device 112 may receive the syntax elements at the video slice level and/or the video block level. Entropy decoding unit 80 may process and parse both fixed-length syntax elements and variable-length syntax elements in or more parameter sets, such as a VPS, SPS, and PPS.

When the video slice is coded as an intra-coded (I) slice, intra prediction processing unit 84 of prediction processing unit 81 may generate prediction data for a video block of the current video slice based on a signaled intra-prediction mode and data from previously decoded blocks of the current frame or picture. When the video frame is coded as an inter-coded (e.g., B, P or GPB) slice, motion compensation unit 82 of prediction processing unit 81 produces predictive blocks for a video block of the current video slice based on the motion vectors and other syntax elements received from entropy decoding unit 80. The predictive blocks may be produced from one of the reference pictures within a reference picture list. The decoding device 112 may construct the reference frame lists, List 0 and List 1, using default construction techniques based on reference pictures stored in picture memory 92.

Motion compensation unit 82 determines prediction information for a video block of the current video slice by parsing the motion vectors and other syntax elements, and uses the prediction information to produce the predictive blocks for the current video block being decoded. For example, motion compensation unit 82 may use one or more syntax elements in a parameter set to determine a prediction mode (e.g., intra- or inter-prediction) used to code the video blocks of the video slice, an inter-prediction slice type (e.g., B slice, P slice, or GPB slice), construction information for one or more reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by the encoding device 104 during encoding of the video blocks to calculate interpolated values for sub-integer pixels of reference blocks. In this case, motion compensation unit 82 may determine the interpolation filters used by the encoding device 104 from the received syntax elements, and may use the interpolation filters to produce predictive blocks.

Inverse quantization unit 86 inverse quantizes, or de-quantizes, the quantized transform coefficients provided in the bitstream and decoded by entropy decoding unit 80. The inverse quantization process may include use of a quantization parameter calculated by the encoding device 104 for each video block in the video slice to determine a degree of quantization and, likewise, a degree of inverse quantization that should be applied. Inverse transform processing unit 88 applies an inverse transform (e.g., an inverse DCT or other suitable inverse transform), an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, the decoding device 112 forms a decoded video block by summing the residual blocks from inverse transform processing unit 88 with the corresponding predictive blocks generated by motion compensation unit 82. Summer 90 represents the component or components that perform this summation operation. If desired, loop filters (either in the coding loop or after the coding loop) may also be used to smooth pixel transitions, or to otherwise improve the video quality. Filter unit 91 is intended to represent one or more loop filters such as a deblocking filter, an adaptive loop filter (ALF), and a sample adaptive offset (SAO) filter. Although filter unit 91 is shown in FIG. 3 as being an in loop filter, in other configurations, filter unit 91 may be implemented as a post loop filter. The decoded video blocks in a given frame or picture are then stored in picture memory 92, which stores reference pictures used for subsequent motion compensation. Picture memory 92 also stores decoded video for later presentation on a display device, such as video destination device 122 shown in FIG. 1.

In this manner, the decoding device 112 of FIG. 3 represents an example of a video decoder configured to perform the techniques described herein. For instance, the decoding device 112 may perform any of the techniques described herein, including the processes described herein.

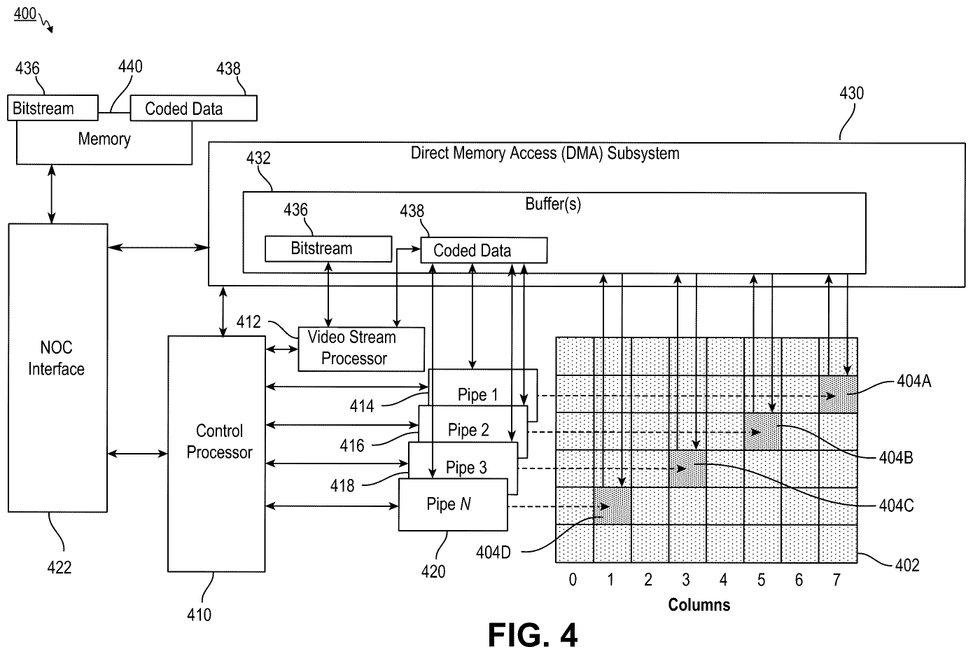

FIG. 4 is a block diagram illustrating an example architecture 400 of a video coding hardware engine that can be used to perform video coding operations (e.g., encoding and/or decoding of video data). For example, the example architecture 400 of the video coding hardware engine can be used to implement a video encoding engine, a video decoding engine, or both. In some cases, the architecture 400 can be implemented by the encoding device 104 and/or decoding device 112 shown in FIG. 1. In some examples, the architecture 400 can be implemented by the encoder engine 106 of the encoding device 104 or by the decoder engine 116 of the decoding device 112, as shown in FIG. 1.

In this example, the architecture 400 of the video coding hardware engine can include a control processor 410, an interface 422, a video stream processor (VSP) 412, processing pipelines 414-420 (also referred to as “pipes”), a direct memory access (DMA) subsystem 430, and one or more buffers 432. In some examples, the architecture 400 can include memory 440 for storing data such as frames, videos, coding information, outputs, etc. In other examples, the memory 440 can be external memory on the coding device implementing the video coding hardware engine.

The interface 422 can transfer data between components of the video coding hardware engine and/or the video coding device through a communication system or system bus on the video coding hardware engine and/or the coding device implementing the video coding hardware engine. For example, the interface 422 can connect the control processor 410, VSP 412, processing pipelines 414-420 (e.g., video pixel processor (VPP)), DMA subsystem 430, and/or one or more buffers 432 with a system bus on the video coding hardware engine and/or the coding device. In some examples, the interface 422 can include a network-based communications subsystem, such as a network-on-chip (NoC). In some examples, the interface 422 (e.g., NoC, etc.) can be implemented or provided between DDR memory and the DMA subsystem 430 (and/or a control processor thereof). For example, in some cases the DMA subsystem 430 may access the memory 440 through the interface 422. DDR memory traffic (e.g., from memory 440) can pass through the NoC (e.g., interface 422), followed by the DMA subsystem 430, before being passed to one or more video IP blocks of the video coding architecture 400 (e.g., where the one or more video IP blocks are associated with at least the processing pipelines 414-420). The control processor associated with and/or included within the DMA subsystem 430 can communicate directly with the NoC and can thereby communicate indirectly with the DDR memory (e.g., communicate indirectly with memory 440 through the interface 422).

In some cases, the bitstream 436 information and/or the coded data 438 may be stored in the one or more buffers 432, which may be implemented as on-chip memory within (e.g., included in) the DMA subsystem 430. In some examples, the bitstream 436 and/or the coded data 438 may be included in the one or more buffers 432, which may be implemented as on-chip memory that is outside of (e.g., not included in) the DMA subsystem 430 and inside of (e.g., included in) the video coding engine (architecture 400). In some examples, the bitstream 436 and/or the coded data 438 can be stored in DDR memory of the video coding engine (architecture 400). For example, the bitstream 436 and/or the coded data 438 can be stored in the memory 440 of the video coding engine (architecture 400), which may be implemented as DDR memory, etc. In some cases where the bitstream 436 and/or the coded data 438 are stored in the on-chip memory (e.g., the one or more buffers 432), the DDR request bandwidth of the video coding engine (architecture 400) can be reduced. Storing the bitstream 436 and/or the coded data 438 in the on-chip memory (e.g., buffer(s) 432) may additionally reduce the read/write latency of the video coding engine (architecture 400).

The DMA subsystem 430 can allow other components of the video coding hardware engine (e.g., other components in the architecture 400) to access memory on the video coding hardware engine and/or the video coding device implementing the video coding hardware engine. For example, the DMA subsystem 430 can provide access to the memory 440 and/or the one or more buffers 432. In some examples, the DMA subsystem 430 can manage access to common memory units and associated data traffic (e.g., tile 402, blocks 404A-D, bitstream 436, entropy coded data 438, etc.).

The memory 440 can include one or more internal or external memory devices such as, for example and without limitation, one or more random access memory (RAM) components, read-only memory (ROM) components, cache memory components, buffer components, and/or other memory devices. The memory 440 can store data used by the video coding hardware engine and/or the video coding device, such as frames, processing parameters, input data, output data, and/or any other type of data.

The control processor 410 can include one or more processors. The control processor 410 can control and/or program components of the video coding hardware engine (e.g., other components in the architecture 400). In some examples, the control processor 410 can interface with other drivers, applications, and/or components that are not shown in FIG. 4. For example, in some cases, the control processor 410 can interface with an application processor on an SOC chip (e.g., which can include a video subsystem, one or more CPUs, one or more GPUs, camera, display, audio, modem, or a combination thereof). For example, the control processor 410 can be included in a video coding subsystem of an SOC of a mobile computing device, smartphone, handset, etc., where the video coding subsystem can include the control processor 410 and a video coding hardware engine, etc., (e.g., a video coding hardware engine according to the video coding engine architecture 400 of FIG. 4, and/or VSP, VPP, etc.).

The VSP 412 can perform bitstream parsing (e.g., separating a network abstraction layer, a picture layer, and a slice layer) and entropy coding operations. In some examples, the VSP 412 can perform coding functions such as variable length encoding or decoding. For example, the VSP 412 can implement a lossless compression and/or decompression algorithm to compress or decompress a bitstream 436. In some examples, the VSP 412 can perform arithmetic coding, such as context, adaptive binary arithmetic coding (CABAC), and/or any other coding algorithm.

The processing pipelines 414-420 can perform video pixel operations such as motion estimation, motion compensation, transform and quantization, image deblocking, and/or any other video pixel operations. In some cases, the processing pipelines 414-420 may perform video pixel operations based on output and/or input of the VSP 412 (e.g., based on the video coding engine (architecture 400) being configured or used to implement video encoding and/or decoding operations). In some cases, output of one VSP 412 may be processed by multiple processing pipelines 414-420. The processing pipelines 414-420 (and/or each individual processing pipeline) can perform specific video pixel operations in parallel. For example, each processing pipeline can perform multiple operations (and/or process data) simultaneously and/or significantly in parallel. As another example, multiple processing pipelines can perform operations (and/or process data) simultaneously and/or significantly in parallel.

In FIG. 4, the processing pipelines 414-420 can store and retrieve video pixel processing data (e.g., video pixel processing outputs, inputs, parameters, pixel data, processing synchronization data, etc.) to and from the one or more buffers 432. In some cases, the one or more buffers 432 can include a single buffer. In other cases, the one or more buffers 432 can include multiple buffers. In some examples, the one or more buffers 432 can include a global input/output line buffer and a pipeline synchronization buffer. In some cases, the pipeline synchronization buffer can temporarily store data used to synchronize data and/or results from video pixel processing operations performed by the processing pipelines 414-420.

In some examples, the VSP 412 can decompress a bitstream 436 associated with a video or sequence of frames, and store coded data 438 (e.g., encoded data in examples where the video coding engine (architecture 400) is used to implement a video encoder and/or video encoding operations, decoded data in examples where the video coding engine (architecture 400) is used to implement a video decoder and/or video decoding operations) associated with the bitstream 436 for processing by the processing pipelines 414-420. In some cases, the coded data 438 may be stored in a memory or buffer and this memory or buffer may be a part of, or separate from buffer 432. In some cases, the VSP 412 can retrieve the bitstream 436 and store the coded data 438 to and from memory using the DMA subsystem 430, which can manage access to memory components and/or units as previously noted. In some cases, the VSP 412 may store the decoded data in an order based on the bitstream. For example, where the bitstream organizes image information based on tiles, the decoded data may be grouped such that decoded data for a tile is stored together, in an order that the tiles are decoded (e.g., in tile order). The processing pipelines 414-420 can retrieve the coded data 438 (e.g., via the DMA subsystem 430) and perform video pixel processing operations on blocks 404A-D of a tile 402 associated with the bitstream 436.

The processing pipelines 414-420 can perform video pixel processing operations in parallel, as previously described. The processing pipelines 414-420 can retrieve and store video pixel processing inputs and outputs from/in the one or more buffers 432 (e.g., via DMA subsystem 430). For example, a motion estimation algorithm implemented by the processing pipeline 414 can perform motion estimation on block 404A and store motion estimation information calculated for block 404A in the one or more buffers 432. A motion compensation algorithm implemented by the processing pipeline 414 can retrieve the motion estimation information from the one or more buffers 432, and use the motion estimation information to perform motion compensation for block 404A. While the motion compensation algorithm is performing the motion compensation, the motion estimation algorithm can perform motion estimation for a next block.

The motion compensation algorithm can store motion compensation results in the one or more buffers 432, which can be accessed and used by transform, quantization, and deblocking algorithms to perform transform, quantization and deblocking for the block 404A. The motion compensation algorithm can perform motion compensation for a next block while the transform, quantization, and/or deblocking algorithms perform the transform, quantization and/or deblocking for the block 404A. The transform, quantization and deblocking algorithms can similarly perform respective operations for the block 404A and the next block in parallel. In some examples, the motion estimation, motion compensation, transform, quantization, and deblocking algorithms can perform respective operations on different blocks in parallel.

The processing pipelines 414-420 can be implemented by hardware and/or software components. For example, the processing pipelines 414-420 can be implemented by one or more pixel processors. In some examples, each processing pipeline can be implemented by one or more hardware components. In some cases, each processing pipeline can use different hardware units and/or components to implement different stages in a pipeline of the processing pipeline. After the video pixel operations are performed to generate output pixels for display, the output pixels for display may be output to a memory, such as the memory 440 or the one or more buffers 432, such as a display buffer. In some cases, the memory 440 may be a system memory or similar memory device, such as a double data rate (DDR) synchronous dynamic random-access memory (SDRAM) or any other memory device. The memory 440 may store the output pixels pending display on a display device.

The number of processing pipelines shown in FIG. 4 is merely an example provided for explanation purposes. One of ordinary skill in the art will appreciate that the architecture 400 can include greater or fewer processing pipelines than shown in FIG. 4. For example, the number of processing pipelines implemented by the architecture 400 can be increased or reduced to include greater or fewer processing pipelines. Moreover, while the architecture 400 is shown to include certain components, one of ordinary skill will appreciate that the architecture 400 can include more or fewer components than those shown in FIG. 4. For example, the architecture 400 can also include, in some instances, other memory devices (e.g., one or more random access memory (RAM) components, read-only memory (ROM) components, cache memory components, buffer components, database components, and/or other memory devices), processing devices (e.g., one or more CPUs, GPUs, and/or other processing devices), interfaces (e.g., internal bus, etc.), and/or other components that are not shown in FIG. 4.

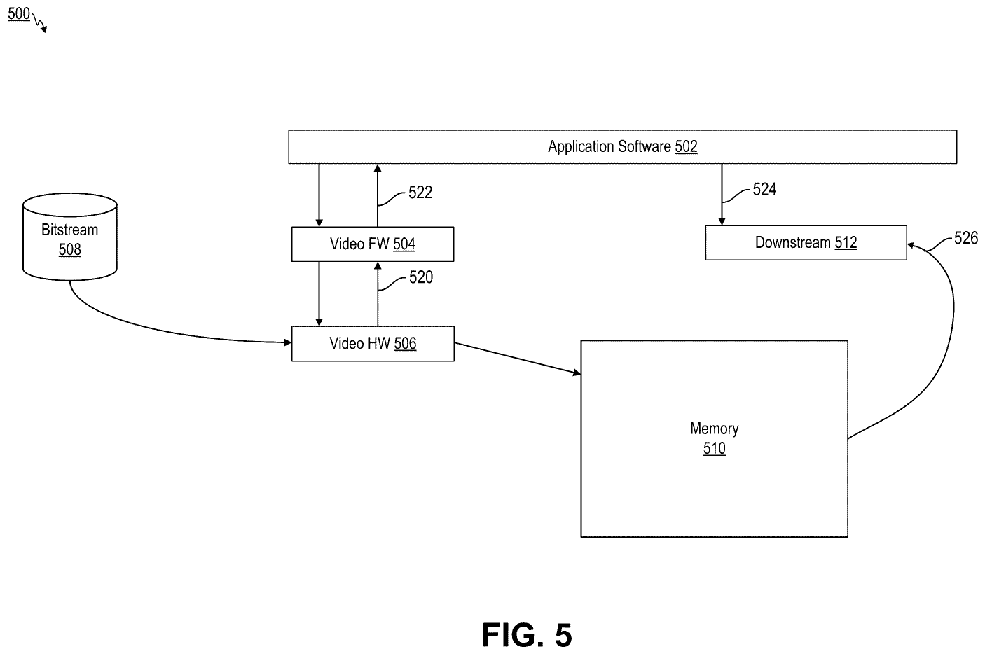

FIG. 5 is a block diagram illustrating an example architecture 500 of a video coding system. In architecture 500, application software 502 may direct video firmware 504 and video hardware 506 to decode a bitstream 508 to memory 510 for downstream device 512 (e.g., a display device, network device to transmit the decoded image to a display device, and the like). In some cases, the application software 502 may be a driver, operating system, higher level user software, and the like. In some cases, the application software 502 may be executing on a CPU or other general purpose processor. The application software 502 may indicate to the video firmware 504 to decode bitstream 508. In some cases, the video firmware 504 may be a control processor for video firmware 504, such as control processor 210 of FIG. 2. The video hardware 506 may include video hardware components for processing video data, such as components from FIG. 2 including VSP 212, processing pipelines 214-220, DMA subsystem 230, interface 222, and the like.

The video firmware 504 may configure the video hardware 506 to obtain and decode the bitstream 508. In some cases, as the video hardware 506 decodes the bitstream 508 into portions of the image, the video hardware 506 may store the portions of the one or more image in the memory 510. In some examples, memory 510 may be the same as or similar to memory 240 of FIG. 2. In some cases, after an image is decoded and ready for display, the image may be stored in the memory 510 by the video hardware 506. The video hardware 506 may also send an interrupt 520 to the video firmware 504 indicating that the image is ready for display. The video firmware 504 can send an interrupt 522 to the application software 502 indicating the image is ready for display. The application software 502 may receive the interrupt 522 and the application software 502 may indicate 524 to the downstream device 512 to obtain 526 the decoded image for display. In some cases, the downstream device 512 may obtain (e.g., receive) 526 the decoded image from memory 510.

As noted previously, systems and techniques are described herein that can be used to perform video coding (e.g., encoding and/or decoding video data) utilizing a video codec parallel processing architecture with reduced leakage power. Leakage power can be power that is used by a particular parallel processing pipeline (e.g., a “pipe”, such as one of the pipes 414-420 of FIG. 4, etc.) while the pipe is powered on and not processing video data. The total power consumption of a video coding architecture and/or a processing pipeline (e.g., one of the pipes 414-420 of FIG. 4) can be represented as Total

$$Power = Dynamic Power + Leakage power = Dynamic Power + ( Active Leakage Power + Non - Active Leakage Power ) .$$

In some cases, larger largest coding unit (LCU) (e.g., coding tree unit (CTU)) sizes used by a video codec can be associated with unbalanced workloads in a corresponding video codec parallel processing architecture, and unbalanced workloads can be associated with increased leakage power consumption by the video codec parallel processing architecture.

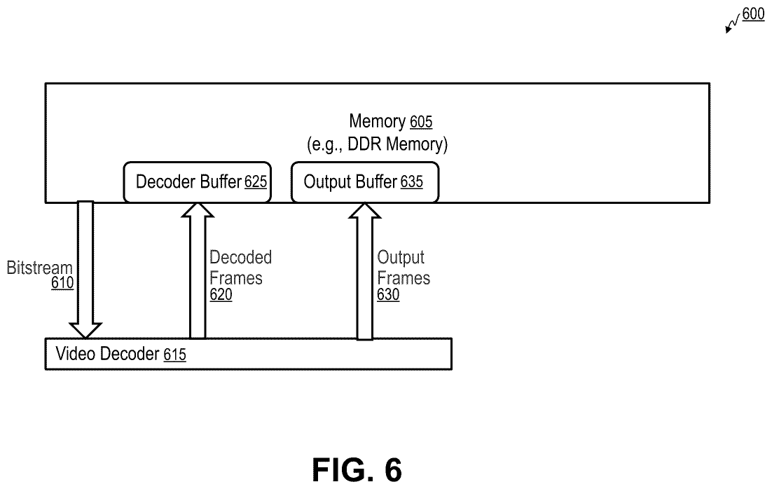

FIG. 6 is a block diagram illustrating a video codec system 600 with a video decoder 615 and a memory 605. The video decoder 615 can be an example of the decoding device 112, the decoder engine 116, the video decoder 815, the video decoder 910, a decoder of the codec system that performs the process 1000, a decoder of the computing system 1100, or a combination thereof, or vice versa. The memory 605 can be an example of the storage 118, the memory 440, the one or more buffers 432, the memory 805, the memory 905, the cache 1112, the memory unit 1115, the ROM 1120, the RAM 1125, the storage device 1130, a Double Data Rate (DDR) memory, or a combination thereof, or vice versa. In some examples, the memory 605 includes a decoder buffer 625, an output buffer 635, or both. The decoder buffer 625 can be referred to as a decoder picture buffer (DPB). The output buffer 635 can be referred to as an output picture buffer (OPB).

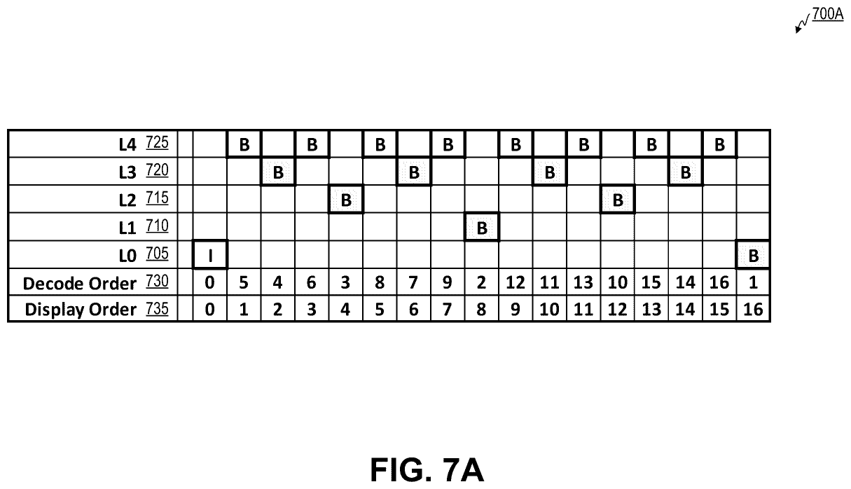

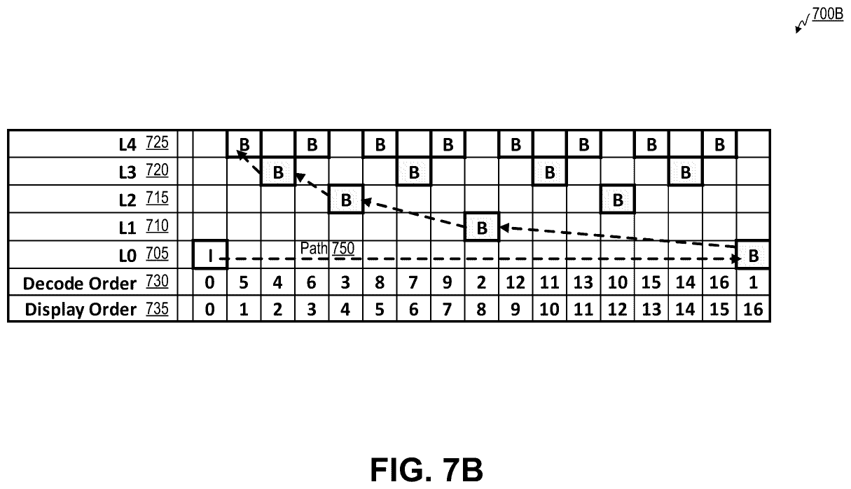

The video decoder 615 can receive a bitstream 610, for instance from an encoder (e.g., encoding device 104, encoder engine 106, or a combination thereof), from the memory 605, or a combination thereof. In some examples, the video decoder 615 receives the bitstream 610 directly from the encoder. In some examples, the memory 605 receives the bitstream 610 (or portion(s) thereof) from the encoder, and the video decoder 615 reads the bitstream 610 (or the portion(s) thereof) from the memory 605. For instance, the memory 605 can serve as the storage 108, the communication link 120, the input 114, and/or the storage 118. The bitstream 610 can be an example of a bitstream sent over the communication link 120, an encoded video bitstream output by the encoding device 104 (and/or by the post processing device 57), an encoded video bitstream received by the decoding device 112 (and/or by the network entity 79), the bitstream 436, the bitstream 508, the example of the bitstream illustrated in FIGS. 7A-7B, the bitstream 810, a bitstream that includes the encoded video frame data of operation 1005, or a combination thereof, or vice versa.

The bitstream 610 includes encoded video frame data corresponding to one or more video frames of a video. Upon receipt of the bitstream 610 (or portion(s) thereof), the video decoder 615 extracts (from the bitstream 610) encoded video frame data corresponding to a specific encoded video frame. The video decoder 615 can decode the encoded video frame data to generate a decoded video frame. The video decoder 615 stores (writes) each such decoded video frame (as decoded frames 620) in the decoder buffer 625 in the memory 605. The decoded frames 620 can have a first image resolution and/or size. In some examples, the first image resolution and/or size can match an original image resolution and/or size of the original video frames of the original video (e.g., from the video source 102) before the original video was encoded by the encoder (e.g., encoding device 104, encoder engine 106). In some examples, the process of encoding the original video by the encoder can change (e.g., reduce) video resolution and/or size of the encoded video compared to the original video, in which case the first image resolution and/or size associated with the decoded frames 620 can differ from the original image resolution and/or size of the original video frames of the original video. The decoded frames 620 can also be referred to as reconstructed frames.

The video decoder 615 can also apply various post-processing operations to the decoded frames 620, such as resizing, resampling, rescaling, film grain, color space conversion, format conversion, tone mapping, sharpness adjustment, brightness adjustment, contrast adjustment, color saturation adjustment, other post-processing operations discussed herein, or a combination thereof. By applying these post-processing operations to the decoded frames 620, the video decoder 615 can generate output frames 630. In some examples, the output frames 630 have a second image resolution and/or size that differs from the first image resolution and/or size of the decoded frames 620. For instance, the post-processing operations applied by the video decoder 615 to the decoded frames 620 to generate the output frames 630 can include resizing, resampling, and/or rescaling (e.g., downsizing, downsampling, downscaling, upsizing, upsampling, and/or upscaling). In some examples, the second image resolution and/or size matches a display resolution and/or size of a display that the output frames 630 are to be displayed on. The output frames 630 can be referred to as processed decoded frames, processed reconstructed frames, or processed frames. The video decoder 615 can store the output frames 630 in the output buffer 635 in the memory 605.

By storing both the decoded frames 620 and the output frames 630 in the memory 605 (e.g., via the decoder buffer 625 and the output buffer 635, respectively), the video codec system 600 ultimately stores multiple instances of the same video frames, which can be considered storage of redundant data (e.g., in that the output frames 630 can be generated from the decoded frames 620). As video codecs advance to support higher resolutions and frame rates of the video data being encoded and decoded, the amount of memory needed to store the decoded frames 620 and the output frames 630 in the memory 605 increases dramatically.

In some examples, a format of the bitstream, and/or which codec is in use, can also cause a memory to store more than one reconstructed video frame in memory, for instance where reconstructing a specific video frame is dependent on data from one or more previously-reconstructed video frames. For instance, in some cases, a codec such as AV1 can keep 7 to 9 decoded video frames (e.g., of the decoded frames 620)) stored in memory 605 (e.g., in the decoder buffer 625) at a given time to use in decoding subsequent frames, without even factoring in storage of output frames 630 in the output buffer 635. This need to store multiple frames can be exacerbated when a decode order differs from a display order, as in the examples illustrated in FIGS. 7A-7B. These aspects, combined, can result in the memory storing a significant amount of data (e.g., a significant number of video frames), for instance including multiple reconstructed video frames and, in some cases, processed variants of one or more of the reconstructed video frames. Furthermore, as users move toward smaller portable devices (e.g., phones, watches, rings, glasses, HMDs, wearable devices, and/or other portable devices), space in memory can be increasingly limited in such devices. Thus, there is a need for improved memory management for video coding hardware architectures and/or for video coding operations.

FIG. 7A is a block diagram 700A illustrating a bitstream for a video with a group of pictures (GOP) structure with multiple temporal layers and a decode order 730 that differs from a display order 735. The GOP structure is used in many codecs, including MPEG-2, H.264, and H.265. The GOP structure illustrated in FIG. 7A may be a hierarchical prediction structure with temporal scalability, such as hierarchical B prediction structure. The temporal layers are hierarchical and include a temporal layer L0 705, a temporal layer L1 710, a temporal layer L2 715, a temporal layer L3 720, and a temporal layer L4 725. The temporal layer L0 705 has no dependencies on data from any other temporal layer. The temporal layer L1 710 is dependent on data from the temporal layer L0 705. The temporal layer L2 715 is dependent on data from the temporal layer L1 710 and the temporal layer L0 705. The temporal layer L3 720 is dependent on data from the temporal layer L2 715, the temporal layer L1 710, and the temporal layer L0 705. The temporal layer L4 725 is dependent on data from the temporal layer L3 720, the temporal layer L2 715, the temporal layer L1 710, and the temporal layer L0 705.

Each square with an “I” or “B” in the block diagram 700A of the bitstream represents a video frame. The I frame is in the temporal layer L0 705 and represents an intra-coded frame. The remaining frames are marked with a “B,” which refers to bidirectionally predicted frames. Image data in bidirectionally predicted frames can be based on the appearance and positions of blocks in past and/and future frames. In some examples, certain frames may also be predicted frames (e.g., which may be marked with a “P”), which may be predicted based on prior I or P frames as well as data indicating changes. For instance, in the MPEG-2 codec, a sequence of video frames can be encoded in the order I, P, B, B, P, B, B, P, B, B, I, P, B, B, P, B, B, P, B, B, and so forth. For the sake of illustration, however, the sequence of frames illustrated in the block diagram 700A includes 17 frames, with only I and B frames.

Each column in the block diagram 700A includes only one video frame. Each video frame belongs to one of the temporal layers (e.g., the temporal layer L4 725, the temporal layer L3 720, the temporal layer L2 715, the temporal layer L1 710, and the temporal layer L0 705), which is indicated based on the row that the video frame is illustrated in. The temporal layers that the video frames are in can dictate the decode order 730 of the video frames. Meanwhile, the display order 735 of the video frames proceeds through the video frames from left to right as illustrated in the block diagram 700A, with the display order 735 numbers the frames in increasing order from 0 to 16. The decode order 730 likewise numbers the frames in increasing order from 0 to 16, but is based on the temporal layers instead of the left-to-right sequence of the video frames. As noted previously, the decode order 730 differs from the display order 735.

The I frame is the first frame (and is thus identified with the sequence number 0) in both the decode order 730 and the display order 735. The I frame is the first frame in the display order 735 because the I frame is furthest left (e.g., earliest in time) in the sequence of frames. The I frame is the first frame in the decode order 730 because the I frame is the earliest frame (according to the display order 735) that is in the temporal layer L0 705. The second frame in the decode order 730 is the last frame in the display order 735, as the second frame in the decode order 730 is the only other frame in the temporal layer L0 705. Thus, the decode order 730 and the display order 735 already start to differ after the first frame. The difference between the decode order 730 and the display order 735 is further illustrated in FIG. 7B.

FIG. 7B is a block diagram 700B illustrating the bitstream for the video of FIG. 7A, with a path 750 overlaid showing how decoding, processing, and display of the video can cause storage of frame data for multiple frames in memory. The path 750 identifies all of the video frames that a decoder (e.g., video decoder 615) decodes (e.g., in the decode order 730) before the decoder can decode the second frame in the display order 735. For instance, the decoder first decodes and stores (e.g., as one of the decoded frames 620 in the decoder buffer 625) the I frame, which is first (numbered 0) in both the decode order 730 and the display order 735. Thus, the I frame is the start of the path 750.

As shown by the path 750, the decoder next decodes and stores (e.g., as one of the decoded frames 620 in the decoder buffer 625) the B frame that is second (numbered 1) in the decode order 730 but seventeenth (numbered 16) in the display order 735. As shown by the path 750, the decoder next decodes and stores (e.g., as one of the decoded frames 620 in the decoder buffer 625) the B frame that is third (numbered 2) in the decode order 730 (e.g., as the only video frame in the temporal layer L1 710) but ninth (numbered 8) in the display order 735. As shown by the path 750, the decoder next decodes and stores (e.g., as one of the decoded frames 620 in the decoder buffer 625) the B frame that is fourth (numbered 3) in the decode order 730 (e.g., as the earliest video frame in the display order 735 that is in the temporal layer L2 715) but fifth (numbered 4) in the display order 735. As shown by the path 750, the decoder next decodes and stores (e.g., as one of the decoded frames 620 in the decoder buffer 625) the B frame that is fifth (numbered 4) in the decode order 730 (e.g., as the earliest video frame in the display order 735 that is in the temporal layer L3 720) but third (numbered 2) in the display order 735. As shown by the path 750, the decoder next finally decodes and stores (e.g., as one of the decoded frames 620 in the decoder buffer 625) the B frame that is sixth (numbered 5) in the decode order 730 (e.g., as the earliest video frame in the display order 735 that is in the temporal layer L4 725) but second (numbered 1) in the display order 735.

Thus, if the decoder wishes to display the second video frame (numbered 1) in the display order 735, the decoder decodes and stores (e.g., in the decoder buffer 625) the five other video frames along the path 750 before decoding and storing (e.g., also in the decoder buffer 625) the second video frame (numbered 1) in the display order 735. In situations where the decoder also stores additional instances of each of those five other video frames (e.g., processed variants stored as the output frames 630 in the output buffer 635), this can cause the decoder to store ten or more video frames in the memory 605 (e.g., across the decoder buffer 625 and the output buffer 635) before the decoder is able to decode the second video frame (numbered 1) in the display order 735. For video frames with a 4K resolution (e.g., 3840 pixels×2160 pixels, 3840 pixels×2400 pixels, or 4096 pixels×2160 pixels) storage of those five decoded frames (e.g., in the decoder buffer 625) and their corresponding processed variants (e.g., in the display order 735) can use 100 megabytes (MB) or more of memory, which is a significant amount for DDR memory or other fast memory types. After decoding and processing the second video frame (numbered 1) in the display order 735, the decoder can, in some cases, store twelve or more video frames in the memory 605, which can occupy even more memory.

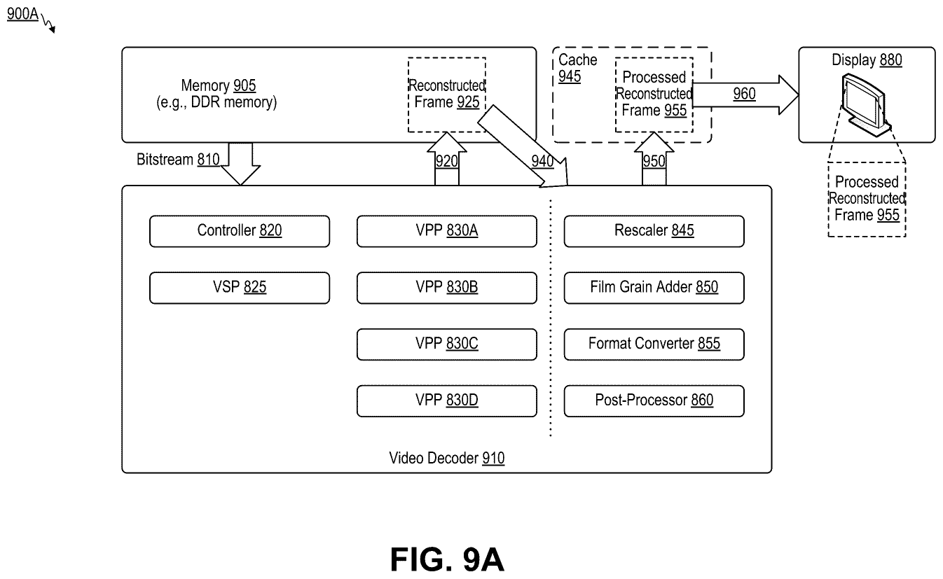

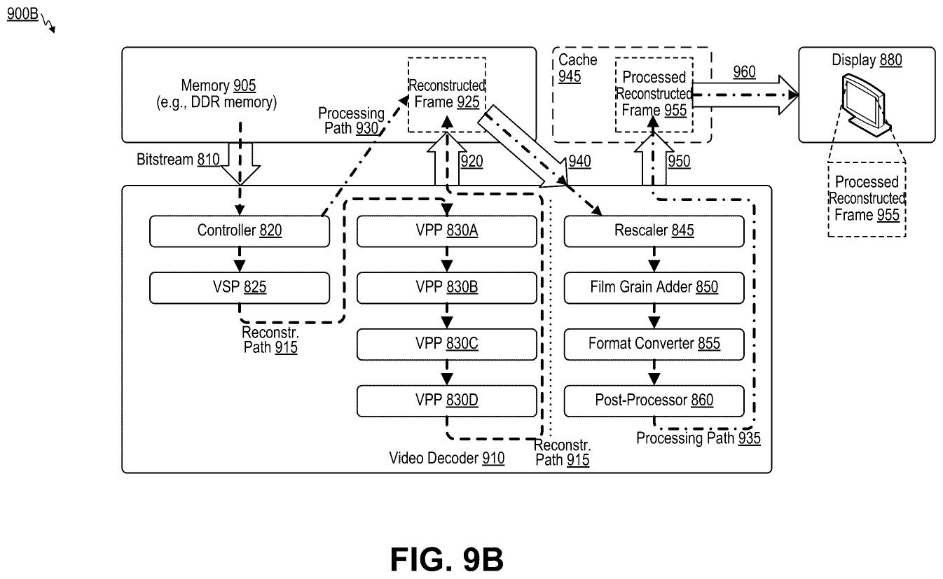

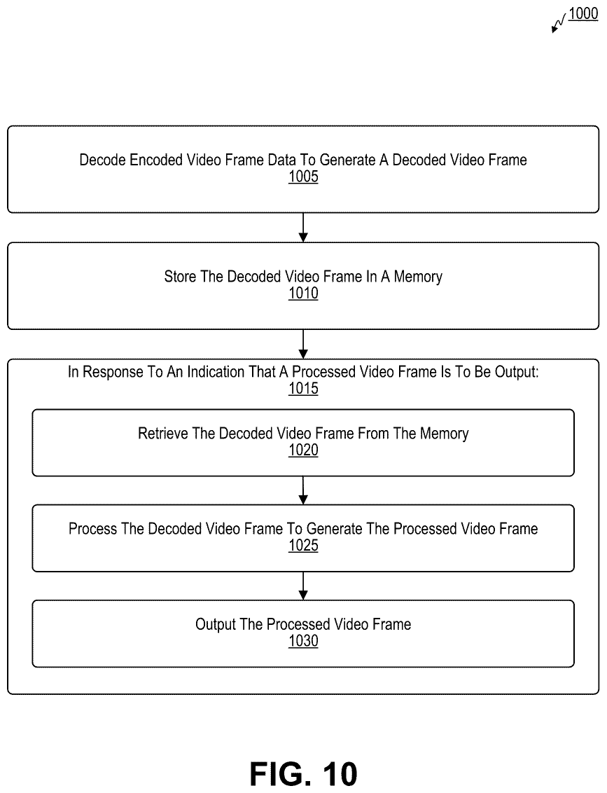

A way to reduce or eliminate storage of processed video frames (e.g., in the output buffer 635) as described herein (e.g., as illustrated in FIGS. 9A-9B and FIG. 10) can significantly reduce memory usage, for instance by 50 MB or more in the situation illustrated in FIGS. 7A-7B. Even higher video resolutions (e.g. 8K resolution) and/or increased number of temporal layers (e.g., addition of a temporal layer L5 that is dependent on the temporal layer L4 725, the temporal layer L3 720, the temporal layer L2 715, the temporal layer L1 710, and the temporal layer L0 705, and so forth) can use up even more memory, especially if processed video frames are stored (e.g., in the output buffer 635) as frames are decoded. A way to reduce or eliminate storage of processed video frames (e.g., in the output buffer 635) as described herein (e.g., as illustrated in FIGS. 9A-9B and FIG. 10) can save even more memory at even higher video resolutions and/or increased number of temporal layers.

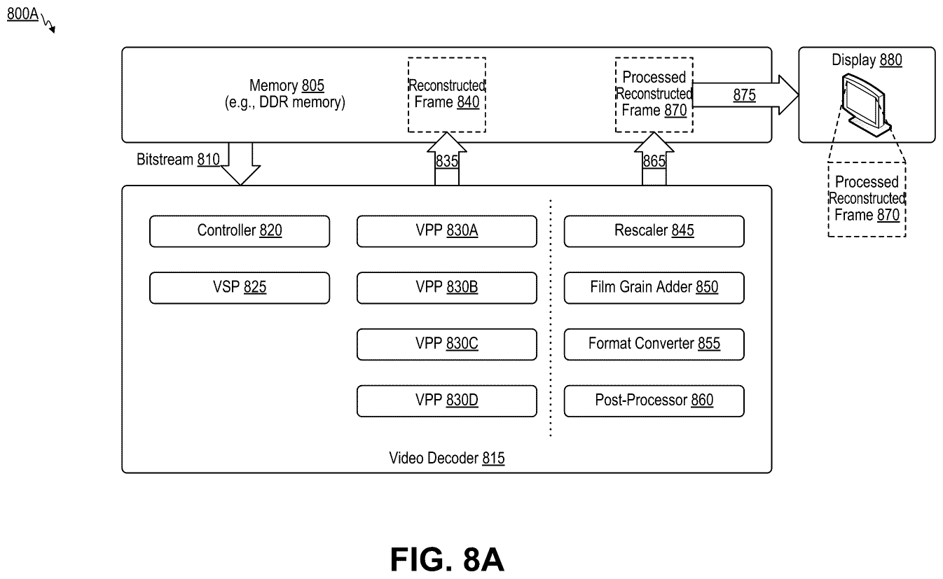

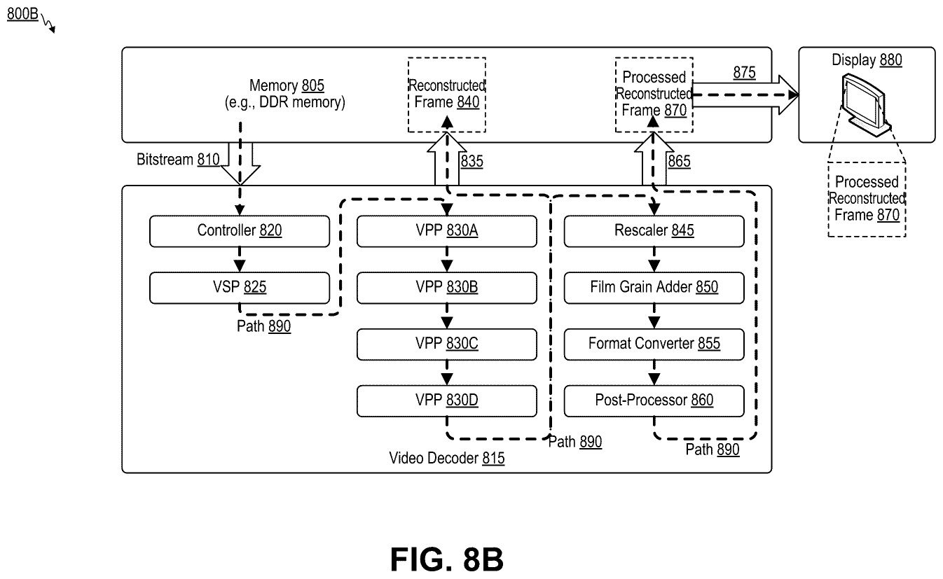

FIG. 8A is a block diagram 800A illustrating a video codec system that decodes and processes an encoded frame from a bitstream 810 for a video to generate, and store within a memory 805, both a reconstructed frame 840 and a processed reconstructed frame 870. The memory 805 can be an example of the storage 118, the memory 440, the one or more buffers 432, the memory 605, the memory 905, the cache 1112, the memory unit 1115, the ROM 1120, the RAM 1125, the storage device 1130, a Double Data Rate (DDR) memory, or a combination thereof, or vice versa. The video codec system includes a video decoder 815. In some examples, the memory 805 includes a decoder buffer 625 and/or an output buffer 635, like the memory 605. The video decoder 815 can be an example of the decoding device 112, the decoder engine 116, the video decoder 615, the video decoder 910, a decoder of the codec system that performs the process 1000, a decoder of the computing system 1100, or a combination thereof, or vice versa.

The video decoder 815 can receive the bitstream 810, for instance from an encoder (e.g., encoding device 104, encoder engine 106, or a combination thereof), from the memory 805, or a combination thereof. In some examples, the video decoder 815 receives the bitstream 810 directly from the encoder. In some examples, the memory 805 receives the bitstream 810 (or portion(s) thereof) from the encoder, and the video decoder 815 reads the bitstream 810 (or the portion(s) thereof) from the memory 805. For instance, the memory 805 can serve as the storage 108, the communication link 120, the input 114, and/or the storage 118. In some examples, the receipt of the bitstream 810 by the video decoder 815 can be achieved via the video decoder 815 performing one or more read operations from the memory 805. The bitstream 810 can be an example of a bitstream sent over the communication link 120, an encoded video bitstream output by the encoding device 104 (and/or by the post processing device 57), an encoded video bitstream received by the decoding device 112 (and/or by the network entity 79), the bitstream 436, the bitstream 508, the bitstream 610, the example of the bitstream illustrated in FIGS. 7A-7B, a bitstream that includes the encoded video frame data of operation 1005, or a combination thereof, or vice versa.

The bitstream 810 includes encoded video frame data corresponding to one or more video frames of a video. Upon receipt of the bitstream 810 (or portion(s) thereof), the video decoder 815 extracts (from the bitstream 810) encoded video frame data corresponding to a specific encoded video frame. The video decoder 815 decodes the encoded video frame data (e.g., using a controller 820, a VSP 825, a VPP 830A, a VPP 830B, a VPP 830C, and/or a VPP 830D) to generate the reconstructed frame 840. The reconstructed frame 840 can be referred to as a decoded frame, a decoded video frame, or a reconstructed video frame. The reconstructed frame 840 can be an example of the decoded frames 620 and/or of the reconstructed frame 925. The video decoder 815 performs a write operation(s) 835 to store the reconstructed frame 840 in the memory 805 (e.g., in a decoder buffer 625 of the memory 805). The video decoder 815 applies post-processing operations (e.g., using a rescaler 845, a film grain adder 850, a format converter 855, and/or a post-processor 860) to the reconstructed frame 840 to generate the processed reconstructed frame 870. The processed reconstructed frame 870 can be referred to as a processed decoded frame, a processed decoded video frame, a processed reconstructed video frame, a processed frame, a processed video frame, a display decoded frame, a display decoded video frame, a display reconstructed frame, a display reconstructed video frame, a display frame, a display video frame, an output decoded frame, an output decoded video frame, an output reconstructed frame, an output reconstructed video frame, an output frame, or an output video frame. The processed reconstructed frame 870 can be an example of the output frames 630 and/or of the processed reconstructed frame 955.

The video decoder 815 performs write operation(s) 865 to store the processed reconstructed frame 870 in the memory 805 (e.g., in an output buffer 635 of the memory 805). In some examples, an output device (e.g., a display 880) can retrieve (in a read operation 875) the processed reconstructed frame 870 and output (e.g., display) the processed reconstructed frame 870.

A dotted line is illustrated through the video decoder 815, separating the decoding components of the video decoder 815 (e.g., the controller 820, the VSP 825, and the VPPs 830A-830D) from the post-processing components of the video decoder 815 (e.g., the rescaler 845, the film grain adder 850, the format converter 855, and the post-processor 860). A path 890 through the decoding operations of the decoding components and through the post-processing operations of the post-processing components is illustrated and described in further detail in FIG. 8B.

FIG. 8B is a block diagram 800B illustrating the video codec system of FIG. 8A, with a path 890 overlaid showing how an encoded frame from the bitstream is decoded, processed, and displayed. As noted above, upon receipt of the bitstream 810 (or portion(s) thereof), the video decoder 815 extracts (from the bitstream 810) encoded video frame data corresponding to a specific encoded video frame. The video decoder 815 decodes the encoded video frame data (e.g., using the controller 820, the VSP 825, the VPP 830A, the VPP 830B, the VPP 830C, and/or the VPP 830D) to generate the reconstructed frame 840. The controller 820 controls receipt of encoded video data via the bitstream 810. In some examples, the controller programs the registers for the VSP 825 and/or the VPP(s) 830A-830D. These registers contain the memory address(es) that store the bitstream or any other information that may be needed or used by VSP 825 and/or VPP(s) 830A-830D. In some examples, then, the controller 820 sends instructions to VSP 825 and/or VPP(s) 830A-830D, with the instructions letting the VSP 825 and VPP(s) 830A-830D know where to fetch the bitstream 810 and/or any other related information. In some examples, the controller 820 can send at least a portion of the bitstream 810 to the VSP 825 and/or the VPP(s) 830A-830D. the encoded video data to the VSP 825 and the VPPs 830A-830D. The controller 820 can be an example of the control processor 410, the application software 502, the video firmware 504, the video hardware 506, a combination thereof, or vice versa.

In some examples, the VSP 825 identifies and/or parses the syntax of the encoded video frame data in the bitstream 810, for instance to identify which data in the bitstream 810 corresponds to which frame(s), and/or to identify which data in the bitstream 810 corresponds to different categories of data. The VSP 825 can be an example of the VSP 412, or vice versa. The VPPs 830A-830D decode the encoded video frame data from the 810 to generate the 840. In some examples, each of the VPPs 830A-830D correspond to, and/or are examples of, the processing pipelines 414-420, or vice versa. In some examples, the VPPs 830A-830D store the reconstructed frame 840 in the memory 805 (e.g., in the decoder buffer 625 of the memory 805) via the write operation(s) 835. While the path 890 illustrates the VPPs 830A-830D as processing (decoding) the encoded video frame data from the bitstream 810 in an order from the VPP 830A to the VPP 830D, it should be understood that at least some of the decoding and/or storage operations can be performed in parallel as illustrated in the parallel operation(s) of the processing pipelines 414-420 of FIG. 4.

The path 890 splits after the decoding of the encoded video frame data using the VPPs 830A-830D. The split in the 890 shows that the video decoder 815 both stores (e.g., via the write operation(s) 835) the reconstructed frame 840 in the memory 805 (e.g., in the decoder buffer 625 of the memory 805) and continues to process the reconstructed frame 840 via post-processing operations (e.g., using the rescaler 845, the film grain adder 850, the format converter 855, and/or the post-processor 860) to generate the processed reconstructed frame 870. The rescaler 845 can rescale the reconstructed frame 840, for instance via resizing, resampling, rescaling, downsizing, downsampling, downscaling, upsizing, upsampling, and/or upscaling the reconstructed frame 840. In some examples, the rescaler 845 resizes, resamples, and/or rescales the reconstructed frame 840 based on a size or resolution of the display 880. The film grain adder 850 adds film grain to the partially-processed reconstructed frame (e.g., a variant of the reconstructed frame 840 that is rescaled). In some examples, the film grain can be at least partially based on a random noise generator (e.g., a white noise generator). In some examples, the film grain can be generated based on film grain parameters and/or characteristics (e.g., associated with the original video that was encoded) stored in the bitstream 810. The format converter 855 can convert the color space, image format, and/or video format of the partially-processed reconstructed frame (e.g., a variant of the reconstructed frame 840 that is rescaled and/or that has film grain added). For instance, in some examples, the format converter 855 can convert the color space from a luminosity/red projection/blue projection (YUV) color space to a red/green/blue (RGB) color space. In some examples, the format converter 855 can convert the partially-processed reconstructed frame to a different image format and/or video format, for instance associated with a different image codec and/or a different video codec. In some examples, the format converter 855 can perform encoding and/or decoding operations as part of such a format conversion. The post-processor 860 can apply other post-processing operations to the partially-processed reconstructed frame (e.g., a variant of the reconstructed frame 840 that is rescaled, that has film grain added, and/or that is converted to a different format). For instance, the post-processor 860 can perform tone mapping, sharpness adjustment, brightness adjustment, contrast adjustment, color saturation adjustment, other post-processing operations discussed herein, or a combination thereof. Note that while the rescaler 845, the film grain adder 850, the format converter 855, and the post-processor 860 are illustrated in that order, it should be understood that a different order can be used, and/or that some of these post-processing components can operate in parallel.

The video decoder 815 performs write operation(s) 865 to store the processed reconstructed frame 870 in the memory 805 (e.g., in an output buffer 635 of the memory 805). In some examples, an output device (e.g., a display 880) can retrieve (in a read operation 875) the processed reconstructed frame 870 and output (e.g., display) the processed reconstructed frame 870.

By storing both the reconstructed frame 840 and the processed reconstructed frame 870 in the memory 805 (e.g., via the decoder buffer 625 and the output buffer 635, respectively), the video codec system 800 ultimately stores multiple instances of the same video frame, which can be considered storage of redundant data (e.g., in that the processed reconstructed frame 870 can be generated from the reconstructed frame 840). As video codecs advance to support higher resolutions and frame rates of the video data being encoded and decoded, the amount of memory needed to store the reconstructed frame 840 and the processed reconstructed frame 870 in the memory 805, especially for multiple frames (e.g., as in the five frames stored due to the mismatch between the decode order 730 and the display order 735 in FIGS. 7A-7B) increases dramatically.

FIG. 9A is a block diagram 900A illustrating a video codec system that decodes an encoded frame from the bitstream 810 for the video to generate and store (within the memory 805) a reconstructed frame 925, and retrieves the reconstructed frame 925 (from the memory 805) to generate and output a processed reconstructed frame 955. The video codec system of FIG. 9A includes a memory 905. The memory 905 can be an example of the storage 118, the memory 440, the one or more buffers 432, the memory 605, the memory 805, the cache 1112, the memory unit 1115, the ROM 1120, the RAM 1125, the storage device 1130, a Double Data Rate (DDR) memory, or a combination thereof, or vice versa. The video codec system includes a video decoder 910. In some examples, the memory 905 includes a decoder buffer 625 and/or an output buffer 635, like the memory 605. In some examples, the memory 905 includes a decoder buffer 625 but lacks (does not include) an output buffer 635. The video decoder 910 can be an example of the decoding device 112, the decoder engine 116, the video decoder 615, the video decoder 815, a decoder of the codec system that performs the process 1000, a decoder of the computing system 1100, or a combination thereof, or vice versa.

Similarly to the video decoder 815 of FIGS. 8A-8B, the video decoder 910 of FIGS. 9A-9B includes decoding components of the video decoder 910 (e.g., the controller 820, the VSP 825, and the VPPs 830A-830D) and post-processing components of the video decoder 910 (e.g., the rescaler 845, the film grain adder 850, the format converter 855, and the post-processor 860), separated by a dotted line. The decoding components of the video decoder 910 (e.g., the controller 820, the VSP 825, and the VPPs 830A-830D) each perform the respective functions of the corresponding decoding components of the video decoder 815 discussed above with respect to FIGS. 8A-8B. The post-processing components of the video decoder 910 (e.g., the rescaler 845, the film grain adder 850, the format converter 855, and the post-processor 860) each perform the respective functions of the corresponding post-processing components of the video decoder 815 discussed above with respect to FIGS. 8A-8B.

The video decoder 910 of FIGS. 9A-9B differs from the video decoder 815 of FIGS. 8A-8B in that the video decoder 910 of FIGS. 9A-9B separates (in time) decoding operations from post-processing operations. For instance, while the operations of the video decoder 815 follow a path 890 that includes both decoding and post-processing, the operations of the video decoder 910 follow a reconstruction path 915 and a processing path 935 that can occur at separate times.

FIG. 9B is a block diagram 900B illustrating the video codec system of FIG. 9A, with a reconstruction path 915 (showing generation and storage of the reconstructed frame 925) and a processing path 935 (showing generation and output of the processed reconstructed frame 955) overlaid. The reconstruction path 915 can be referred to as the decoding path. The reconstruction path 915 is similar to the beginning of the path 890. In particular, the reconstruction path 915 includes the video decoder 910 receiving the bitstream 810 (or portion(s) thereof) from an encoder and/or from memory 905, similarly to the video decoder 815 receiving the bitstream 810 (or portion(s) thereof) from an encoder and/or from the memory 805. The reconstruction path 915 includes use of the decoding components of the video decoder 910 (e.g., the controller 820, the VSP 825, and the VPPs 830A-830D) to generate the reconstructed frame 925 and to write (e.g., using write operation(s) 920) the reconstructed frame 925 to the memory 905 (e.g., to a decoder buffer 625 of the memory 905). The reconstructed frame 925 can be referred to as a decoded frame, a decoded video frame, or a reconstructed video frame. The reconstructed frame 925 can be an example of the decoded frames 620 and/or of the reconstructed frame 840.

The video decoder 910 initiates the processing path 935 in response to receipt (e.g., at the controller 820) of an indication that a video frame is to be output (e.g., displayed). In some examples, the indication that the video frame is to be output can be an instruction from hardware (e.g., an input received at a physical button or virtual button corresponding to a “play” command), an instruction from software (e.g., an indication that a video player software had reached a certain point in a video and should play a specific video frame or sequence of video frames next), or a combination thereof. In some examples, the video decoder 910 does not perform the processing path 935 otherwise (e.g., the video decoder 910 only initiates the processing path 935 in response to the indication that a video frame is to be output). In some examples, the video decoder 910 initiates the processing path 935 in response to receipt of the indication that the video frame is to be output allows the video decoder 910 to initiates the processing path 935 (and thus perform post-processing of the reconstructed frame 925) in a just-in-time fashion, dynamically as needed to output (e.g., display) the reconstructed frame 925 (or the processed reconstructed frame 955 as a processed variant thereof).

In the processing path 935, the video decoder 910 retrieves (e.g., via read operation(s) 940) the reconstructed frame 925 from the memory 905 (e.g., from the decoded frames 620 of the memory 905). The rest of the processing path 935 is similar to the end of the path 890. In particular, the processing path 935 applies post-processing operations to the reconstructed frame 925 using the post-processing components of the video decoder 910 (e.g., the rescaler 845, the film grain adder 850, the format converter 855, and the post-processor 860) to generate the processed reconstructed frame 955.

The processed reconstructed frame 955 can be referred to as a processed decoded frame, a processed decoded video frame, a processed reconstructed video frame, a processed frame, a processed video frame, a display decoded frame, a display decoded video frame, a display reconstructed frame, a display reconstructed video frame, a display frame, a display video frame, an output decoded frame, an output decoded video frame, an output reconstructed frame, an output reconstructed video frame, an output frame, or an output video frame. The processed reconstructed frame 955 can be an example of the output frames 630 and/or of the processed reconstructed frame 870.

In some examples, the video decoder 910 sends the processed reconstructed frame 955 directly to an output device (e.g., the display 880 or a transmitter) so that the output device (e.g., the display 880 or a transmitter) outputs (e.g., displays or transmits) the processed reconstructed frame 955. In some examples, video decoder 910 temporarily stores (e.g., via write operation(s) 950) the processed reconstructed frame 955 in a cache 945, and the output device (e.g., the display 880 or a transmitter) can read (e.g., via read operation(s) 960) the processed reconstructed frame 955 from the cache 945. In some examples, the cache 945 can be a system cache, a display buffer, a display cache, R, on-chip memory, DDR memory, or a section of the memory 905.

Due to the just-in-time nature of the post-processing (e.g., through the processing path 935), the cache 945, if used at all, only needs enough storage space to store a single processed frame (e.g., the processed reconstructed frame 955) at a time. Thus, the amount of memory or storage space used in the cache 945 is significantly smaller than the amount of memory or storage space used in the output buffer 635 of the memory 605 and/or of the memory 805. Even in a situation in which a decode order differs from a display order as in FIGS. 7A-7B, the cache 945, if used at all, only needs enough storage space to store a single processed frame (e.g., the processed reconstructed frame 955) at a time.

In an illustrative example in reference to FIGS. 7A-7B, if the decoder wishes to display the second video frame (numbered 1) in the display order 735, the video decoder 910 still decodes and stores (e.g., in the decoder buffer 625 of the memory 905) the five other video frames along the path 750 before decoding and storing (e.g., also in the decoder buffer 625 of the memory 905) the second video frame (numbered 1) in the display order 735. However, video decoder 910 does not generate or store processed variants of those five other video frames along the path 750 before generating (e.g., and temporarily storing in the cache 945 for output by the display 880) the processed variant (e.g., the processed reconstructed frame 955) of the second video frame (numbered 1) in the display order 735. This differs from the video decoder 615 and the video decoder 815, which do generate and store processed variants of those five other video frames along the path 750 before generating (e.g., and storing in the output buffer 635 of the memory 605 and/or the memory 805) the processed variant (e.g., the processed reconstructed frame 870) of the second video frame (numbered 1) in the display order 735

Because the cache 945 (if used by the video decoder 910) only needs enough storage space to store a single processed frame (e.g., the processed reconstructed frame 955) at a time, the video codec system of FIGS. 9A-9B can use types of memory that are faster and smaller than the memory (e.g., memory 605, memory 805, and memory 905), such as system cache, or on-chip memory. Thus, the write operation(s) 950 and/or the read operation(s) 960 can be faster than the write operation(s) 865 and/or the read operation(s) 875, respectively. This increase in speed of the write operation(s) 950 and/or the read operation(s) 960 (compared to the write operation(s) 865 and/or the read operation(s) 875) means that the video decoder 910 uses a matching amount of time, or less time, in the interactions with memory and/or storage (e.g., memory 905 and/or cache 945) compared to the video decoder 815's interactions with memory 805.

Furthermore, in some examples, the video decoder 910 uses the same amount of data interactions with the memory 905 per frame as the video decoder 815's amount of data interactions with the memory 805 per frame. For instance, the read operation(s) associated with the video decoder 910 reading the bitstream 810 match the read operation(s) associated with the video decoder 815 reading the bitstream 810, the write operation(s) 920 associated with the video decoder 910 writing the reconstructed frame 925 to the memory 905 (e.g., to the decoder buffer 625 of the memory 905) match the write operation(s) 835 associated with the video decoder 815 writing the reconstructed frame 840 to the memory 805 (e.g., to the decoder buffer 625 of the memory 805), and the data interactions during the read operation(s) 940 associated with the video decoder 910 reading the reconstructed frame 925 from the memory 905 (e.g., from the decoder buffer 625 of the memory 905) are similar to the data interactions during the write operation(s) 865 associated with the video decoder 815 writing the processed reconstructed frame 870 to the memory 805 (e.g., to the output buffer 635 of the memory 805).

In some examples, the video decoder 910 can further reduce memory bandwidth usage compared to the video decoder 815. In some examples, because the cache 945 (if used by the video decoder 910) only needs enough storage space to store a single processed frame (e.g., the processed reconstructed frame 955) at a time, the video decoder 910 is compatible with devices that have more limited amounts of memory (e.g., portable devices such as wearable devices) compared to the video decoder 815.

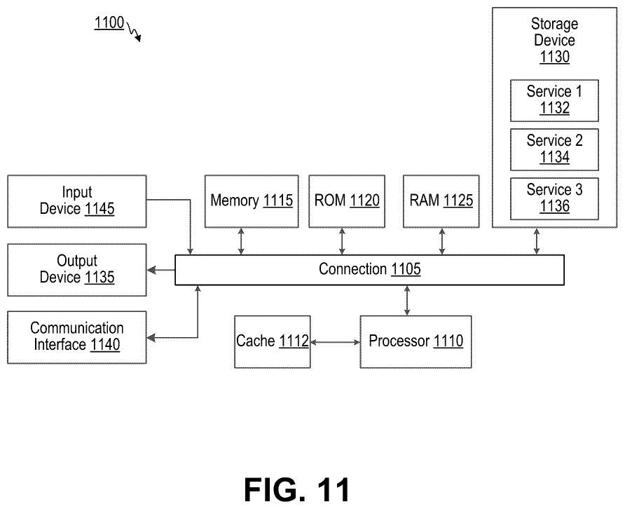

FIG. 10 is a flow chart illustrating an example of a process 1000 for video decoding and/or video processing. The process 1000 can be performed by a codec system, which may include the system 100, video source 102, the encoding device 104, decoding device 112, the communication link 120, the video destination device 122, architecture 400, the control processor 410, the NOC interface 422, the DMA subsystem 430, the one or more buffers 432, the memory 440, the architecture 500, the video hardware 506, memory 510, the video codec system 600, the memory 605, the video decoder 615, the decoder buffer 625, the output buffer 635, the decoder of FIGS. 7A-7B, the video codec system of FIGS. 8A-8B, the memory 805, the memory 805, the video decoder 815, the display 880, the video codec system of FIGS. 9A-9B, the cache 945, the computing system 1100 of FIG. 11, a computing device, a processor executing instructions stored in a memory, a processor executing instructions stored in a non-transitory computer-readable storage medium, a component of sub-system of any of these systems, a head-mounted display (HMD), a headset, a mobile handset, a wireless communication device, a wearable device, or a combination thereof. In some examples, process 1000 is performed by a component or system (e.g., a chipset, one or more processors such as one or more central processing units (CPUs), digital signal processors (DSPs), graphics processing units (GPUs), any combination thereof, and/or other type of processor(s), or other component or system) of the 3D reconstruction system. The operations of the process 1000 may be implemented as software components that are executed and run on one or more processors (e.g., processor 1110 of FIG. 11 or other processor(s)). Further, the transmission and reception of signals by the computing device in the process 1000 may be enabled, for example, by one or more antennas and/or one or more transceivers (e.g., wireless transceiver(s)).

At operation 1005, the codec system (or a component or subsystem thereof) is configured to, and can, decode encoded video frame data to generate a decoded video frame. Examples of the encoded video frame data can include video data encoded by an encoder (e.g., encoding device 104, encoder engine 106), encoded video data output via the output 110, encoded video data received via the input 114, encoded video data transferred via the communication link 120, encoded video data received via a network entity 79, the encoded video bitstream of FIG. 3, the bitstream 436, the coded data 438, the bitstream 508, the bitstream 610, the bitstream 810, other encoded video data discussed herein, or a combination thereof.

Examples of the decoded video frame can include video data decoded using a decoder (e.g., decoding device 112, decoder engine 116), decoded video data sent to and/or received by a video destination device 122, blocks 404A-404D, the decoded image(s) obtained 526 by the downstream device 512, the decoded frames 620, the video data decoded according to the decode order 730 in FIGS. 7A-7B, the reconstructed frame 840, the reconstructed frame 925, or a combination thereof.

In some aspects, the codec system (or a component or subsystem thereof) is configured to, and can, receive the encoded video frame data (of operation 1005) from an encoder, such as the encoding device 104, the encoder engine 106, or a combination thereof. For instance, the encoded video frame data can be received via the output 110, the input 114, the communication link 120, the network entity 79, or a combination thereof.

In some aspects, decoding the encoded video frame data (as in operation 1005) includes processing the encoded video frame data using at least one video stream processor (VSP) and at least one video pixel processor (VPP). Examples of the VSP include the VSP 412, the application software 502, the video firmware 504, the video hardware 506, a VSP of the video decoder 615, the VSP 825. Examples of the VPP include the processing pipelines 414-420, the application software 502, the video firmware 504, the video hardware 506, VPP(s) of the video decoder 615, the VPP(s) 830A-830D.

In some aspects, decoding the encoded video frame data (as in operation 1005) includes omitting post-processing of the decoded video frame. For instance, the reconstruction path 915 of FIG. 9B omits post-processing of the reconstructed frame 925. Instead, post-processing of the reconstructed frame 925 is performed later as part of the processing path 935.

At operation 1010, the codec system (or a component or subsystem thereof) is configured to, and can, store the decoded video frame in a memory. Examples of the memory include the storage 118, the DMA subsystem 430, one or more buffers 432, the memory 440, the memory 605, the memory 805, the memory 905, the cache 945, the cache 1112, the memory unit 1115, the ROM 1120, the RAM 1125, the storage device 1130, a Double Data Rate (DDR) memory, a non-transitory computer-readable storage medium, another type of memory discussed herein, another type of storage device discussed herein, another type of storage medium discussed herein, or a combination thereof. Examples of the storing include the storing of the 620 in the decoder buffer 625, the write operation(s) 835, and the write operation(s) 920.

In some aspects, storing the decoded video frame in the memory (as in operation 1010) includes avoiding storing of any other instance of the decoded video frame in the memory, avoiding storing of any instance of the processed video frame in the memory, or a combination thereof. For instance, in the process illustrated in FIGS. 9A-9B, the memory 905 can store the reconstructed frame 925 without storing the processed reconstructed frame 955. This differentiates from the process illustrated in FIGS. 8A-8B, in which the memory 805 stores both the reconstructed frame 840 and the processed reconstructed frame 870.

At operation 1015, the codec system (or a component or subsystem thereof) is configured to, and can, perform certain operations in response to an indication that a processed video frame is to be output. In some examples, the indication is received from the application software 502, detected by the controller 820, received from the display 880, or a combination thereof.

These operations (performed in response to the indication) include an operation 1020, in which the codec system (or a component or subsystem thereof) is configured to, and can, retrieve the decoded video frame from the memory (e.g., as in the read operation(s) 940). These operations include an operation 1025, in which the codec system (or a component or subsystem thereof) is configured to, and can, process the decoded video frame (e.g., as in the processing path 935) to generate the processed video frame (e.g., output frames 630, processed reconstructed frame 870, processed reconstructed frame 955). These operations include an operation 1030, in which the codec system (or a component or subsystem thereof) is configured to, and can, output the processed video frame (e.g., via write operation(s) 950, read operation(s) 960, output via the 880, output via the output device 1135 and/or the communications interface 1140, or a combination thereof).

In some aspects, outputting the processed video frame (as in operation 1030) includes storing the processed video frame in a display buffer, in a system cache, in the memory, in a Double Data Rate (DDR) memory, a non-transitory computer-readable storage medium, the storage 118, the DMA subsystem 430, one or more buffers 432, the memory 440, the memory 605, the memory 805, the memory 905, the cache 945, the cache 1112, the memory unit 1115, the ROM 1120, the RAM 1125, the storage device 1130, another type of memory discussed herein, another type of storage device discussed herein, another type of storage medium discussed herein, or a combination thereof. In some aspects, the memory (of operation 1010) is a Double Data Rate (DDR) memory, a non-transitory computer-readable storage medium, the storage 118, the DMA subsystem 430, one or more buffers 432, the memory 440, the memory 605, the memory 805, the memory 905, the cache 945, the cache 1112, the memory unit 1115, the ROM 1120, the RAM 1125, the storage device 1130, another type of memory discussed herein, another type of storage device discussed herein, another type of storage medium discussed herein, or a combination thereof.

In some aspects, processing the decoded video frame (as in operation 1025) includes applying a color space conversion to the decoded video frame to convert the decoded video frame from a first color space to a second color space (e.g., as in the format converter 855), applying a format conversion to the decoded video frame to convert the decoded video frame from a first format to a second format (e.g., as in the format converter 855), adding film grain to the decoded video frame (e.g., as in the film grain adder 850), rescaling the decoded video frame from a first resolution to a second resolution (e.g., as in the rescaler 845), another video processing operation discussed herein (e.g., as in the post-processor 860), another image processing operation discussed herein (e.g., as in the post-processor 860), or a combination thereof. In some aspects, processing the decoded video frame (as in operation 1025) includes applying rescaler 845, the film grain adder 850, the format converter 855, the post-processor 860, the processing path 935, any other post-processing or filters of the decoding device 112 of FIG. 1 and/or FIG. 3, any other post-processing or filters discussed herein, or a combination thereof.

The process 1000 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1000 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a block diagram illustrating an example of a computing system 1100 that can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing system 1100 may include, implement, or be included in any or all of the encoding device 104 of FIG. 1 and/or FIG. 2, another video source-side device or video transmission device, the decoding device 112 of FIG. 1 and/or FIG. 3, another client-side device, such as a player device, a display, or any other client-side device, the architecture 400 of FIG. 4, the architecture 500 of FIG. 5, the video codec system 600, the decoder of FIGS. 7A-7B, the video codec system of FIGS. 8A-8B, the video codec system of FIGS. 9A-9B, the cache 945, the codec system that performs the process 1000 of FIG. 10, the computing system 1100 of FIG. 11, or a combination thereof. Additionally or alternatively, the computing system 1100 may be configured to perform process 1000 of FIG. 10, and/or other process described herein.

In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some aspects, computing system 1100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1100 includes at least one processing unit (CPU or processor) 1110 and connection 1105 that communicatively couples various system components including system memory (e.g., memory unit 1115), such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100.

Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1140 may also include one or more range sensors (e.g., LIDAR sensors, laser range finders, RF radars, ultrasonic sensors, and infrared (IR) sensors) configured to collect data and provide measurements to processor 1110, whereby processor 1110 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some aspects, a hardware service that performs a particular function can include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus to process video data, the apparatus comprising: one or more memories configured to store the video data; and one or more processors coupled to the one or more memories, the one or more processors being configured to: decode encoded video frame data to generate a decoded video frame; store the decoded video frame in a memory of the one or more memories; retrieve the decoded video frame from the memory in response to an indication that a processed video frame is to be output; process the decoded video frame to generate the processed video frame in response to the indication; and output the processed video frame in response to the indication.

Aspect 2. The apparatus of Aspect 1, wherein, to decode the encoded video frame data, the one or more processors are configured to process the encoded video frame data using at least one video stream processor (VSP) and at least one video pixel processor (VPP).

Aspect 3. The apparatus of Aspect 1 or Aspect 2, wherein, to output the processed video frame, the one or more processors are configured to store the processed video frame in a display buffer.

Aspect 4. The apparatus of any of Aspects 1 to 3, wherein, to output the processed video frame, the one or more processors are configured to store the processed video frame in a system cache.

Aspect 5. The apparatus of any of Aspects 1 to 4, wherein, to output the processed video frame, the one or more processors are configured to store the processed video frame in the memory.

Aspect 6. The apparatus of any of Aspects 1 to 5, wherein, to output the processed video frame, the one or more processors are configured to store the processed video frame in a Double Data Rate (DDR) memory.

Aspect 7. The apparatus of any of Aspects 1 to 6, wherein the memory is a Double Data Rate (DDR) memory.

Aspect 8. The apparatus of any of Aspects 1 to 7, wherein to process the decoded video frame, the one or more processors are configured to apply a color space conversion to the decoded video frame to convert the decoded video frame from a first color space to a second color space.

Aspect 9. The apparatus of any of Aspects 1 to 8, wherein to process the decoded video frame, the one or more processors are configured to apply a format conversion to the decoded video frame to convert the decoded video frame from a first format to a second format.

Aspect 10. The apparatus of any of Aspects 1 to 9, wherein to process the decoded video frame, the one or more processors are configured to add film grain to the decoded video frame.

Aspect 11. The apparatus of any of Aspects 1 to 10, wherein to process the decoded video frame, the one or more processors are configured to rescale the decoded video frame from a first resolution to a second resolution.

Aspect 12. The apparatus of any of Aspects 1 to 11, wherein, to decode the encoded video frame data, the one or more processors are configured to omit post-processing of the decoded video frame.

Aspect 13. The apparatus of any of Aspects 1 to 12, wherein, to store the decoded video frame in the memory, the one or more processors are configured to avoid storing any other instance of the decoded video frame in the memory.

Aspect 14. The apparatus of any of Aspects 1 to 13, wherein, to store the decoded video frame in the memory, the one or more processors are configured to avoid storing any instance of the processed video frame in the memory.

Aspect 15. The apparatus of any of Aspects 1 to 14, wherein the one or more processors are configured to: receive the encoded video frame data from an encoder.

Aspect 16. A method of video processing, the method comprising: decoding encoded video frame data to generate a decoded video frame; storing the decoded video frame in a memory; retrieving the decoded video frame from the memory in response to an indication that a processed video frame is to be output; processing the decoded video frame to generate the processed video frame in response to the indication; and outputting the processed video frame in response to the indication.

Aspect 17. The method of Aspect 16, wherein decoding the encoded video frame data includes processing the encoded video frame data using at least one video stream processor (VSP) and at least one video pixel processor (VPP).

Aspect 18. The method of Aspect 16 or Aspect 17, wherein outputting the processed video frame includes storing the processed video frame in a display buffer.

Aspect 19. The method of any of Aspects 16 to 18, wherein outputting the processed video frame includes storing the processed video frame in a system cache.

Aspect 20. The method of any of Aspects 16 to 19, wherein outputting the processed video frame includes storing the processed video frame in the memory.

Aspect 21. The method of any of Aspects 16 to 20, wherein outputting the processed video frame includes storing the processed video frame in a Double Data Rate (DDR) memory.

Aspect 22. The method of any of Aspects 16 to 21, wherein the memory is a Double Data Rate (DDR) memory.

Aspect 23. The method of any of Aspects 16 to 22, wherein processing the decoded video frame includes applying a color space conversion to the decoded video frame to convert the decoded video frame from a first color space to a second color space.

Aspect 24. The method of any of Aspects 16 to 23, wherein processing the decoded video frame includes applying a format conversion to the decoded video frame to convert the decoded video frame from a first format to a second format.

Aspect 25. The method of any of Aspects 16 to 24, wherein processing the decoded video frame includes adding film grain to the decoded video frame.

Aspect 26. The method of any of Aspects 16 to 25, wherein processing the decoded video frame includes rescaling the decoded video frame from a first resolution to a second resolution.

Aspect 27. The method of any of Aspects 16 to 26, wherein decoding the encoded video frame data includes omitting post-processing of the decoded video frame.

Aspect 28. The method of any of Aspects 16 to 27, wherein storing the decoded video frame in the memory includes avoiding storing of any other instance of the decoded video frame in the memory.

Aspect 29. The method of any of Aspects 16 to 28, wherein storing the decoded video frame in the memory includes avoiding storing of any instance of the processed video frame in the memory.

Aspect 30. The method of any of Aspects 16 to 29, further comprising: receiving the encoded video frame data from an encoder.

Aspect 31. A non-transitory computer-readable medium having stored thereon instructions that, when executed by one or more processors, cause the one or more processors to perform operations according to any of Aspects 1 to 30.

Aspect 32. An apparatus comprising one or more means for performing operations according to any of Aspects 1 to 30.

1. An apparatus for video processing, the apparatus comprising:
one or more memories; and
one or more processors coupled to the one or more memories, the one or more processors being configured to:
decode encoded video frame data to generate a decoded video frame;
store the decoded video frame in a memory of the one or more memories;
receive an indication that a processed video frame corresponding to the decoded video frame is to be displayed on a display;
retrieve the decoded video frame from the memory in response to the indication;
process the decoded video frame based on at least one characteristic of the display to generate the processed video frame in response to the indication; and
output the processed video frame to display circuitry associated with the display without storing the processed video frame in the memory in response to the indication.

2. The apparatus of claim 1, wherein, to decode the encoded video frame data, the one or more processors are configured to process the encoded video frame data using at least one video stream processor (VSP) that parses a syntax of the encoded video frame data and at least one video pixel processor (VPP) that decodes the encoded video frame data based on the parsed syntax.

3. The apparatus of claim 1, wherein, to output the processed video frame to the display circuitry, the one or more processors are configured to store the processed video frame in a display buffer of the display circuitry, wherein the display buffer is distinct from the memory.

4. The apparatus of claim 1, wherein, to output the processed video frame to the display circuitry, the one or more processors are configured to store the processed video frame in a system cache that is distinct from the memory.

5. The apparatus of claim 1, wherein, to output the processed video frame to the display circuitry, the one or more processors are configured to convey the processed video frame to the display.

6. The apparatus of claim 1, wherein, to output the processed video frame to the display circuitry, the one or more processors are configured to display the processed video frame on the display.

7. The apparatus of claim 1, wherein the memory is a Double Data Rate (DDR) memory.

8. The apparatus of claim 1, wherein to process the decoded video frame based on at least one characteristic of the display, the one or more processors are configured to apply a color space conversion to the decoded video frame to convert the decoded video frame from a first color space to a second color space that is associated with the display.

9. The apparatus of claim 1, wherein to process the decoded video frame based on at least one characteristic of the display, the one or more processors are configured to apply a format conversion to the decoded video frame to convert the decoded video frame from a first format to a second format that is associated with the display.

10. The apparatus of claim 1, wherein to process the decoded video frame based on at least one characteristic of the display, the one or more processors are configured to add film grain to the decoded video frame.

11. The apparatus of claim 1, wherein to process the decoded video frame based on at least one characteristic of the display, the one or more processors are configured to rescale the decoded video frame from a first resolution to a second resolution that is associated with the display.

12. The apparatus of claim 1, wherein, to decode the encoded video frame data, the one or more processors are configured to delay post-processing of the decoded video frame until after receipt of the indication.

13. The apparatus of claim 1, wherein, to store the decoded video frame in the memory, the one or more processors are configured to avoid storing any modified instance of the decoded video frame in the memory.

14. The apparatus of claim 1, wherein, to store the decoded video frame in the memory, the one or more processors are configured to avoid storing any instance of the processed video frame in the memory.

15. The apparatus of claim 1, wherein the one or more processors are configured to:
receive the encoded video frame data from an encoder.

16. A method of video processing, the method comprising:
decoding encoded video frame data to generate a decoded video frame;
storing the decoded video frame in a memory;
receiving an indication that a processed video frame corresponding to the decoded video frame is to be displayed on a display;
retrieving the decoded video frame from the memory in response to the indication;
processing the decoded video frame based on at least one characteristic of the display to generate the processed video frame in response to the indication; and
outputting the processed video frame to display circuitry associated with the display without storing the processed video frame in the memory in response to the indication.

17. The method of claim 16, wherein decoding the encoded video frame data includes processing the encoded video frame data using at least one video stream processor (VSP) that parses a syntax of the encoded video frame data and at least one video pixel processor (VPP) that decodes the encoded video frame data based on the parsed syntax.

18. The method of claim 16, wherein outputting the processed video frame to the display circuitry includes storing the processed video frame in a display buffer of the display circuitry, wherein the display buffer is distinct from the memory.

19. The method of claim 16, wherein outputting the processed video frame to the display circuitry includes storing the processed video frame in a system cache that is distinct from the memory.

20. The method of claim 16, wherein outputting the processed video frame to the display circuitry includes conveying the processed video frame to the display.

21. The method of claim 16, wherein outputting the processed video frame to the display circuitry includes displaying the processed video frame on the display.

22. The method of claim 16, wherein the memory is a Double Data Rate (DDR) memory.

23. The method of claim 16, wherein processing the decoded video frame based on at least one characteristic of the display includes applying a color space conversion to the decoded video frame to convert the decoded video frame from a first color space to a second color space that is associated with the display.

24. The method of claim 16, wherein processing the decoded video frame based on at least one characteristic of the display includes applying a format conversion to the decoded video frame to convert the decoded video frame from a first format to a second format that is associated with the display.

25. The method of claim 16, wherein processing the decoded video frame based on at least one characteristic of the display includes adding film grain to the decoded video frame.

26. The method of claim 16, wherein processing the decoded video frame based on at least one characteristic of the display includes rescaling the decoded video frame from a first resolution to a second resolution that is associated with the display.

27. The method of claim 16, wherein decoding the encoded video frame data includes delaying post-processing of the decoded video frame until after receipt of the indication.

28. The method of claim 16, wherein storing the decoded video frame in the memory includes avoiding storing of any modified instance of the decoded video frame in the memory.

29. The method of claim 16, wherein storing the decoded video frame in the memory includes avoiding storing of any instance of the processed video frame in the memory.

30. The method of claim 16, further comprising:
receiving the encoded video frame data from an encoder.
